(19) United States
(12) Patent Application Publication
(10) Pub. No.: US 2022/0284405 A1
(43) Pub. Date: Sep. 8, 2022

(54) MAINTENANCE INFORMATION MANAGEMENT SYSTEM, MAINTENANCE INFORMATION MANAGEMENT DEVICE, MAINTENANCE INFORMATION MANAGEMENT METHOD, AND PROGRAM

(71) Applicant: SERPSS CO., LTD., Tokyo (JP)

(72) Inventor: Hiroyuki HIRANO, Tokyo (JP)

(21) Appl. No.: 17/628,487

(22) PCT Filed: Jul. 13, 2020
(86) PCT No.: PCT/JP2020/027262

§ 371 Date: Jan. 19, 2022

(30) Foreign Application Priority Data
Jul. 19, 2019 (JP) 2019-133934

(51) Int. Cl. G06Q 10/00; G06Q 50/04

(52) U.S. Cl. CPC G06Q 10/20; G06Q 50/04

(57) ABSTRACT

A maintenance information management system and method and a program that can appropriately and centrally manage information of the same industrial equipment in a facility and an equipment and that can improve the efficiency of maintenance management. The maintenance information management system comprises information acquisition unit that acquires a second management target information related to a management target having a plurality of classification items when acquiring account information of companies and employees, acquiring a first management target information related to a management target existing for the purpose of classification, and classifying the management target by any classification item, which is a management target information, and a maintenance management unit for generating maintenance management information in which the account information and the first management target information are associated with each of a plurality of classification items constituting the second management target information, for registering them in a database unit.

### TECHNICAL FIELD

The present invention relates to a maintenance information management system for managing maintenance information related to industrial equipment (plants and industrial equipment constituting a production line, industrial equipment and part constituting a machine), a maintenance information management device and a maintenance information management method, as well as a program.

### BACKGROUND ART

In a manufacturing industry, particularly, a material-based manufacturing industry in which a manufacturing line is constructed by a process automation accompanied by fluid control (food, pharmaceutical, chemical, petroleum, steel, water treatment industry or the like), a factory and the production line are constructed by industrial equipment on the scale of several thousands to several ten thousands of points, and the production is performed, and these maintenance activities (maintenance) are performed for maintenance of the operation. As a system for supporting these maintenance activities and unifying maintenance information, there is known a maintenance information management system for storing maintenance information in a database and managing maintenance information using the data.

For example, in a system related to maintenance information management targeting a plurality of industrial equipment having a common part in an equipment having the same type in a biochemical analyzer or the like, there is known a system in which the maintenance management is performed by assigning a hierarchical number common to all of the company to the equipment and the industrial equipment constituting the equipment (a first prior art: see industrial equipment Patent Document 1 below), and a system related to managing maintenance information in which an equipment having the same type in a semiconductor manufacturing equipment is unitarily managed in all factories, which performs maintenance management by assigning an equipment code common to all the company to the equipment (a second prior art: see Patent Document 2 below).

In the manufacturing industry, the same industrial equipment is generally used in a plurality of locations (factory, a production line, facility, equipment), but there are the following patterns in combination for the industrial equipment, the equipment using the industrial equipment as a part, and in the manufacturer of the equipment whether the industrial equipment is the same or not, whether the industrial equipment is the same or not, or whether the manufacturer is the same or not.

Pattern 1: A pattern in which a plurality of same industrial equipment of the same equipment manufacturer are used, and the industrial equipment constituting the equipment are the same;
Pattern 2: A pattern in which the same industrial equipment is incorporated in different equipment of the same equipment manufacturer;
Pattern 3: A pattern in which the same industrial equipment is incorporated in the equipment of different equipment manufacturers;
Pattern 4: A pattern in which the same industrial equipment is incorporated in a plurality of facilities constructed by the same engineering company; and
Pattern 5: A pattern in which the same industrial equipment is incorporated in a plurality of facilities constructed by different engineering companies.

However, when the above-described respective patterns are present, in the first and second prior art as described above, there has been a problem that it is impossible to unitarily manage (unify the management) the information on the same industrial equipment and another industrial equipment in a factory, a production line, a facility, and a n equipment regardless of different locations and supplier.

In order to solve the above problem, there has been proposed a system (a third prior art) relating to maintenance information management in which maintenance information such as failure information, inspection information, maintenance instruction information or the like is associated with each of parts of the factory (for example, the facility, the production line constituting the facility, and the equipment and the industrial equipment in the equipment), and is registered in a maintenance database, which the respective maintenance information is displayed in units of constituent elements.

### CITATION LIST

### Patent Literature

[PTL 1]
JP 2014-53044 A
[PTL 2]
JP-A-2003-108219

### SUMMARY OF INVENTION

### Technical Problem

The above-described maintenance management of the third prior art is management by a hierarchy, and the configuration of the management target is a factory, a facility A, a facility B, an equipment CC, industrial equipment a-e or a part f provided in the facility A, the facility B, the equipment CC, and a facility D, an equipment EE provided in the line 2, and industrial equipment a-e or a part f provided in the facility D, the equipment EE, the facility D, the equipment EE, an equipment FF, which forms a hierarchical structure as shown in FIG. 3.

Here, for example, a case where a failure occurs in the industrial equipment e of the equipment CC will be discussed below. The industrial equipment e is present in the equipment CC, the facility D, the equipment EE, and the facility B. In the management of these facilities and equipment, the manufacturing section 2 manages the equipment CC and the equipment EE, the manufacturing section 1 manages the facility D, the manufacturing section 3 manages the facility B.

There are industrial equipment that is commonly used in each of these departments, and an efficient maintenance management can be expected if it is possible to understand what kind of facility (equipment) and industrial equipment are used in other departments and what kind of maintenance information is provided. However, in the above-described third prior art, for example, when the information of the industrial equipment e is managed, it is impossible to integrate and confirm the information, even if the same equipment is used because each management information is distributed to each root of the hierarchy tree because of the hierarchical management (for example, even if you try to confirm the information of industrial equipment e from the upper hierarchy of “factory”, the management information for all 18 units will come out), even if a full-text search is performed, it is difficult to extract with pinpoint the information due to the shaking and noise of the search, and the information on lines 1 and 2 is divided into the building 1 and the building 2, so it was difficult to confirm maintenance information on an equipment to be grasped even when an industrial equipment used in common exists in the respective departments. Therefore, there is a problem that efficient maintenance management cannot be performed.

As a department related to industrial equipment, a technical system department, a manufacturing system department, and other departments are mainly considered. The technical system department is a department for performing engineering EPC (design, procurement, execution management), and a department for performing maintenance, and the manufacturing system department is a department in which production and maintenance of the facility are performed by actually moving the facility, and other departments include a research and development department, a quality management department, and the like for examining a product process on a laboratory scale.

Here, as the type of information on the manufacturing facility and the industrial equipment constituting the facility, there are various types of information such as text, document (specification, manual, quality certificate, report, drawings, CAD), and the like. For example, when the facility is introduced, the design investigation information, the procurement information, and the trial run information are present, and after the production is started, the periodic maintenance information, the facility modification, the information at the time when the facility, the industrial equipment are in trouble, the consumables (or the main body) purchase information can be mentioned.

In the digital management in the maintenance information management system according to the third prior art described above, it is logically difficult to register information such as a text and a document on a hierarchy. For example, when the information on a certain industrial equipment is to be obtained, it cannot be obtained unless the whole text is researched from the upper hierarchy, and it is not possible to effectively use the information when desired information is needed.

As described above, although there are industrial equipment of several thousands to several thousands of points on the factory and production lines, there are cases where new line construction, a replacement, a transfer of the equipment and the industrial equipment and the like are generated every year to cope with the new product, and in addition to being difficult to register the industrial equipment related to them in the database, it is necessary to register the industrial equipment for each of different locations, facilities, equipment, etc.

Further, since a different concept (products, process, processing contents, places, departments) is mixed in the hierarchy, it is necessary to define the management hierarchy of the facility and to hierarchically classify the facility into a plurality of management units in order to effectively use the information when desired information is needed. However, there are provided a facility for supplying utility such as heat, water, gas and a facility for collectively receiving from a plurality of production lines such as a filling/packaging, transport facilities, etc., and it is difficult to logically define an optimal management hierarchy. Therefore, there was a problem that it was difficult to define industrial equipment of several thousands to several thousands of points in an appropriate management hierarchy.

Accordingly, it is an object of the present invention to provide a maintenance information management system, a maintenance information management method, and a program capable of appropriately performing unitary management of information of the same industrial equipment in a facility and an equipment regardless of different locations and supplier, and improving efficiency of maintenance management.

### Solution to Problem

In order to solve the above problem, a maintenance information management device according to a first aspect of the present invention includes account information acquisition unit that acquires account information of companies and employees, a first management target information acquisition unit that acquires a first management target information related to a management target that exists for the purpose of classification, a second management target information acquisition unit that acquires a second management target information related to the management target that there is a plurality of classification items when the management target is classified by an arbitrary classification item, and a maintenance management unit that generates maintenance management information that associates the account information and the first management target information with each of the plurality of classification items constituting the second management target information and that registers them in a database unit.

A maintenance information management device according to a second aspect of the present invention is configured so that the database unit includes an account information database in which the account information is registered, a first management target information database in which the first management target information is registered, and a second management target information database in which the second management target information is registered, and further includes: an information acquisition unit that acquires maintenance management information related to the management target associated with the selected classification item when the second management target information associated with any management target included in the first management target information is selected, a display control unit that generates a maintenance management screen in the management target unit based on the maintenance management information acquired by the information acquisition unit, and a display unit that displays the maintenance management screen generated by the display control unit.

A maintenance information management system according to a first aspect of the present invention includes: a maintenance management server device that generates and registers maintenance management information to be managed, and a client terminal provided with a terminal-side display unit that displays maintenance information provided by the maintenance management server device, wherein the maintenance management server device comprises an account information acquisition department that acquires account information of companies and employees, a first management target information acquisition unit that acquires the first management target information related to a management target that exists for the purpose of classification, a second management target information acquisition unit that acquires the second management target information related to the management target in which there are a plurality of classification items when the management target is classified by an arbitrary classification item, which is the management target information, a database unit for registering the account information, the first management target information and the second management target information, a maintenance management department, and a maintenance management unit that generates maintenance management information that associates the account information and the first management target information with each of the plurality of classification items constituting the second management target information and that registers the generated maintenance management information in the database unit.

A maintenance information management system according to a second aspect of the present invention, the maintenance management server device includes a maintenance management information acquisition unit that, when second management target information associated with an arbitrary management target included in first management target information is selected, acquires maintenance management information relating to a management target associated with the selected classification item; and a display control unit that generates a maintenance management screen in units of management on the basis of the maintenance management information acquired by the maintenance management information acquisition unit, and the client terminal includes a display unit that displays the maintenance management screen generated by the display control unit.

In the maintenance information management system according to the third aspect of the present invention, the first management target information is factory information, facility information, equipment information and comment information, and the second management target information is tag information configured to include line tag information, management department tag information, information sharing department tag information, facility classification tag information, equipment classification tag information, comment tag information, and free tag information that can be set arbitrarily, wherein the maintenance management screen includes a factory information screen for displaying the factory information, a facility information screen for displaying the facility information, a equipment information screen for displaying the equipment information, the same equipment in different facilities, comment information for the same equipment, and an industrial equipment master screen that displays information on the facility in which the same equipment is incorporated, an equipment master screen that displays the equipment classification tag to be associated with the same equipment, and a comment information screen that displays comments, wherein the display control unit generates tag registration screen data in response to a request for a tag registration screen capable of selecting the tag information from the client terminal, and supplies the generated tag registration screen data to the terminal side display unit, wherein the terminal side display unit displays the tag registration screen based on the supplied tag registration screen data, wherein the registration information of the tag information is supplied to the maintenance management unit via an operation unit on the client terminal side on the displayed tag registration screen, wherein the maintenance management unit stores the supplied tag information in the second management target information database, executes the registration process of the tag information, and associates the registered tag information with the factory information, the facility information, the equipment information and the comment information, and stores the maintenance management information including the associated factory information, the facility information, the equipment information and the comment information in the first management target information database, wherein the display control unit generates a maintenance management screen in the management target unit based on the associated maintenance management information stored in the first management target information database, and wherein the terminal side display unit displays the maintenance management screen generated by the display control unit.

A maintenance information management method according to a first aspect of the present invention is a maintenance information management method for managing maintenance information to be managed by using a maintenance information management system including a maintenance management server device, includes: acquiring account information of companies and employees by the maintenance management server device, acquiring a first management target information regarding the management target in which the maintenance management server device exists for the purpose of classification, and acquiring a second management target information related to the management target having a plurality of the classification items when the maintenance management server device classifies the management target by an arbitrary classification item, which is the management target information, and generating maintenance management information in which the account information and the first management target information are associated with each of a plurality of classification items constituting the second management target information, and registering them in the database unit by the maintenance management server device.

A maintenance information management method according to a second aspect of the present invention is a maintenance information management method for managing maintenance information to be managed by using a maintenance information management system including a client terminal and a maintenance management server device, includes acquiring account information of companies and employees via an account information acquisition department by the maintenance management server device, acquiring a first management target information related to a management target existing for the purpose of classification by the maintenance management server device, acquiring the second management target information related to a management target having a plurality of classification items when classifying the management target using an arbitrary classification item, which is the management target information by the maintenance management server device, generating maintenance management information in which the account information and the first management target information are associated with each of a plurality of classification items constituting the second management target information, and registering them in a database unit by the maintenance management server device, acquiring maintenance management information related to the management target associated with the selected classification items when the second management target information associated with any management target included in the first management target information is selected, generating the maintenance management screen in the management target unit based on the acquired maintenance management information by the maintenance management server device, and displaying a maintenance management screen generated in the maintenance management server device by the client terminal.

A program according to a first aspect of the present invention is a program for causing a computer to execute a maintenance information management method in a maintenance information management system including a maintenance management server device, includes acquiring a first management target information related to a management target existing for the purpose of classification, acquiring a second management target information related to a management target having a plurality of classification items when classifying the management target using an arbitrary classification item, which is the management target information by a second management target information acquisition unit, and generating and registering maintenance management information in which the account information and the first management target information are associated with each of a plurality of classification items constituting the second management target information.

A program according to a second aspect of the present invention is a program for causing a computer to execute a maintenance information management method in a maintenance information management system including a client terminal and a maintenance management server device, includes acquiring account information of companies and employees by an account information acquisition department in the maintenance management server device, includes acquiring a first management target information related to a management target existing for the purpose of classification by the maintenance management server device, acquiring a second management target information related to a management target having a plurality of classification items when classifying the management target using an arbitrary classification item, which is the management target information by the maintenance management server device, generating maintenance management information in which the account information and the first management target information are associated with each of a plurality of classification items constituting the second management target information, and registering them in a database unit by the maintenance management server device, acquiring maintenance management information related to a management target associated with the selected classification items when the second management target information associated with any management target included in the first management target information is selected, generating the maintenance management screen in the management target unit based on the acquired maintenance management information by the maintenance management server device, and displaying the maintenance management screen generated in the maintenance management server device on a display unit of the client terminal by the client terminal.

### Advantageous Effects of Invention

According to the present invention, it is possible to appropriately perform unitary management of the information of the same industrial equipment in the facility and the equipment, regardless of different locations and supplier, and to improve the efficiency of maintenance management.

### BRIEF DESCRIPTION OF DRAWINGS

FIG. 1 is a diagram illustrating an outline of a maintenance information management system;

FIG. 2 is a diagram illustrating an outline of the relationship between the actual location, the arrangement of the facility, the equipment, the industrial equipment/part, and the management and related departments in the factory;

FIG. 3 is a diagram illustrating a hierarchical structure in the hierarchical management of the conventional maintenance information management system;

FIG. 4 is a diagram illustrating screen transitions for explaining the overall flow of each process of the maintenance information management system;

FIG. 5 is a diagram illustrating selection items displayed on the facility list screen, the equipment list screen, and the equipment master screen;

FIG. 6 is a diagram for explaining “a facility classification tag” and “an equipment classification tag”;

FIG. 7 is a diagram illustrating a state of transitioning to the account management screen, the tag management screen, facility list screen, equipment list screen or catalog list screen, and illustrating the processing contents that can be performed on each screen;

FIG. 8 is a diagram illustrating a state of transitioning to the equipment list screen, the comment entry/display screen, and the equipment master screen, and the processing contents that can be performed on each screen.

FIG. 9 is a flowchart for explaining an example of the processing executed by the server device and the client terminal;

FIG. 10 is a flowchart for explaining another example of processing executed by the server device and the client terminal;

FIG. 11 is a flowchart for explaining still another example of processing executed by the server device and the client terminal;

FIG. 12 is a flowchart for explaining still another example of processing executed by the server device and the client terminal;

FIG. 13 is a flowchart for explaining still another example of processing executed by the server device and the client terminal;

FIG. 14 is a flowchart for explaining still another example of processing executed by the server device and the client terminal;

FIG. 15 is a flowchart for explaining still another example of processing executed by the server device and the client terminal;

FIG. 16 is a flowchart for explaining still another example of processing executed by the server device and the client terminal;

FIG. 17 is a flowchart for explaining still another example of processing executed by the server device and the client terminal;

FIG. 18 is a flowchart for explaining still another example of processing executed by the server device and the client terminal;

FIG. 19 is a flowchart for explaining still another example of processing executed by the server device and the client terminal;

FIG. 20 is a diagram for explaining a post-login top screen;

FIG. 21 is a diagram for explaining transition from the top screen to the account screen;

FIG. 22 is a diagram for explaining an account management screen;

FIG. 23 is a diagram for explaining a tag management screen;

FIG. 24 is a diagram illustrating a left side and a center portion of a facility list screen;

FIG. 25 is a diagram illustrating a right side of the facility list screen;

FIG. 26 is a diagram for explaining processing for associating a department tag on the facility list screen;

FIG. 27 is a diagram illustrating a state of transition from the facility list screen to the equipment list screen;

FIG. 28 is a diagram illustrating a central portion and a left side of the equipment list screen;

FIG. 29 is a diagram illustrating a state of transition from the facility list screen to a document screen;

FIG. 30 is a diagram illustrating a tagging screen to an equipment on the equipment list screen;

FIG. 31 is a diagram illustrating a comment registration screen to an arbitrary equipment on the equipment list screen;

FIG. 32 is a diagram illustrating a state of transition from the equipment master screen to the comment display screen;

FIG. 33 is a diagram illustrating a state of transition from the equipment master screen to a number display screen for each facility of an arbitrary equipment;

FIG. 34 is a diagram illustrating a state of transition from the top screen to the equipment master screen;

FIG. 35 is a diagram illustrating a screen related to the matrix information and a screen on which a determination result corresponding to the selected comment tag are displayed;

FIG. 36 is a diagram illustrating a screen for performing integrated search;

FIG. 37 is a diagram illustrating a state of transition from the top screen to a screen related to comment information registered by a department to which the user belongs;

FIG. 38 is a diagram illustrating a state of selecting an arbitrary department is for transition from the top screen to a screen related to comment information registered by an arbitrary department;

FIG. 39 is a diagram in which comment information associated with an arbitrary department tag is extracted, and illustrating a screen related to comment information associated with the extracted department tag.

### DESCRIPTION OF EMBODIMENTS

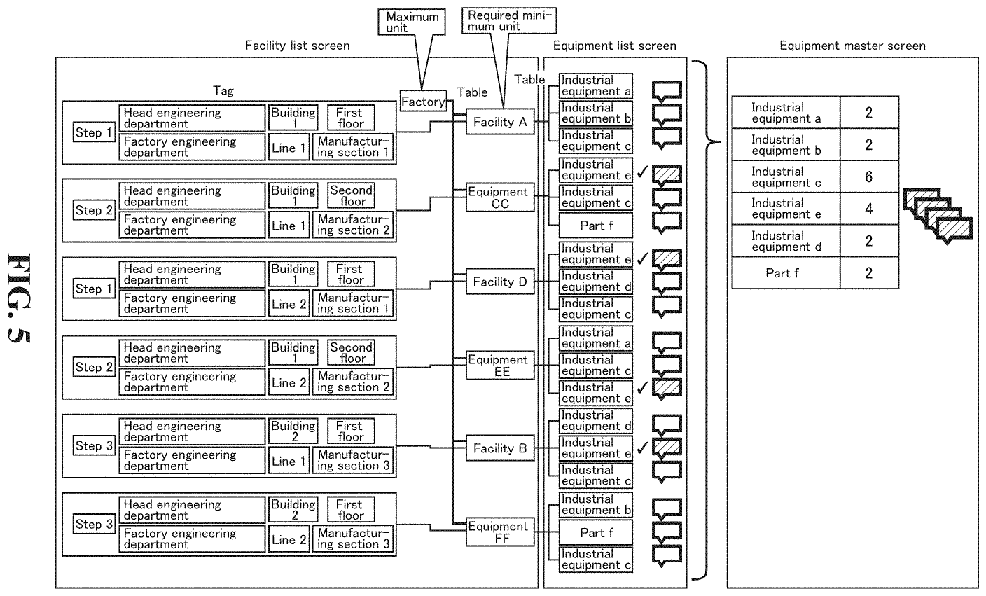

The present invention is characterized in that hierarchy of multiple and different attributes are provided between a factory having a maximum unit and a facility (equipment) having a minimum unit in the prior art, while a factory as a maximum unit and a facility (equipment) as a minimum unit are tagged as shown in FIG. 5. Therefore, since the information of the same industrial equipment incorporated in different facilities (facility A, facility B, facility D, equipment CC, equipment EE, equipment FF) can be integrated, information on the same industrial equipment in the facility and the equipment can be unitarily managed regardless of different locations and supplier. In the example of FIG. 5, the industrial equipment e is incorporated in different facilities and equipment (facility B, facility D, equipment CC, and facility EE), but it is possible to display comment information on the industrial equipment e in different facilities and information on the incorporated facilities, by selecting the industrial equipment e on an equipment master screen as described later.

A hierarchical process (table normalization process) and a tag process, which are features of the present invention, will now be described. Hereinafter, an object to be managed is referred to as a “management target”, and an attribute item for classifying the “management target” is referred to as a “classification item”, and a name for performing classification with respect to the “classification item” is referred to as a “classification name”. In addition, the purpose of using the tag is to extract and totalize the information of the management target by dividing the information into an arbitrary attribute and a range. The management target present as a classification target includes, for example, a factory, a facility, a plant, a equipment, an industrial equipment, a part and a comment, and the information on these management target corresponds to the first management target information of claim 1. On the other hand, when the management object is classified by an arbitrary classification item, for example, a line tag, a management department tag, an information sharing department tag, a facility classification tag, an equipment classification tag, a comment classification tag, and a free tag described later are listed, and the information on the management object corresponds to the second management object information of claim 1.

First, table normalization processing will be described. A user is a facility, a plant, an equipment, a machine, an industrial equipment and part constituting these, and a unit for managing a management object such as a part in a factory or a laboratory. These information are stored in a factory information database 4, which will be described later. Next, a facility, a plant, an equipment, and a machine are used as a unit to be managed by the user. These information are stored in a facility information database 5, which will be described later. Next, an industrial equipment or a part is used as a unit to be managed which constitutes a facility, a plant, an equipment, and a machine. These information are stored in an industrial equipment information database 7, which will be described later. Each of the databases described above performs information processing for normalization of a table (database) in which the facility information database 5 is the highest order and then the facility information database 5 and the industrial equipment information database 7 are used as the highest order.

Next, the tag processing will be described. As an attribute for classifying and managing a management target such as a facility, a plant, an equipment, a machine, an equipment and a part constituting the facility, the plant, the equipment, and the part, there are various attributes other than the attribute such as a factory or a laboratory. As an attribute for classifying and managing the management target itself, the management target is referred to as an attribute (hereinafter, referred to as a “first top attribute”). An exemplary embodiment of the present invention will be described in detail based on the following figures, wherein: A congenital attribute that an facility (equipment), a plant, and an industrial equipment (machine) to be managed in advance is created as a “facility classification tag” or an “industrial equipment classification tag” by a maintenance management unit 18 to be described later, and performs tag processing on the management target described above, that is, association processing of the management target and the facility classification tag, and association processing of the management target and the equipment classification tag.

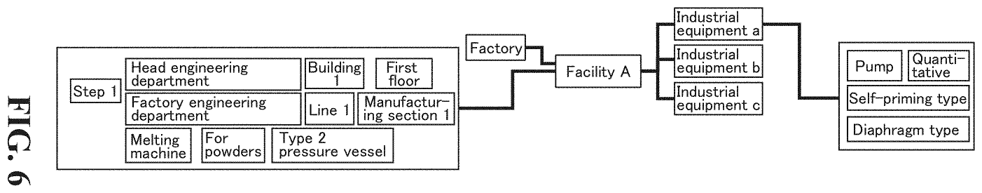

In the example of FIG. 6, the management target facility A performs processing for associating the facility classification tag with the facility A to be managed by creating the tag information as the “facility classification tag” in the congenital attribute of the melting machine, the powder equipment, or the second type pressure container that the facility A to be managed in advance. Furthermore, tag information is created using a pump, a fixed amount, a self-priming type, and a diaphragm type that the industrial equipment A to be managed has in advance, as an “industrial equipment classification tag”, and a related communication process is performed on the industrial equipment A to be managed. Tag information as the created “facility classification tag” and “industrial equipment classification tag” is stored in a tag information database (DB) 9.

Here, the attribute (hereinafter, referred to as “rear-top attribute”) given later by the user to the management target other than the above-described congenital attribute is referred to as “rear-top attribute”. There are some cases. Examples of the acquired attribute include a “line tag”, a “department (include section) tag”, a “comment classification tag”, and a “free tag”. The “line tag” is created as a “line tag” for a name of a manufacturing line in which a facility is incorporated, and a facility (equipment) to be managed, a plant, an equipment (machine), a part constituting these, and the like are associated with each other. In the example of FIG. 6, the facility A is associated with the line 1. The tag information as the “line tag” is stored in the tag information database (DB).

The department tag is referred to as a “management department tag” (hereinafter referred to as a “department tag”) of a department of a user who manages a management object and a department to which information is desired to be shared. A facility (equipment) to be managed, a plant, an equipment (machine), a part constituting these, and the like are associated with each other. In the example of FIG. 6, a department tag, such as a head engineering unit, a factory engineering unit, and a manufacturing 1 section, is associated with a facility A to be managed. The tag information as the created “facility classification tag” and the “industrial equipment classification tag” is stored in the tag information database (DB).

In addition, various attributes are created as free tags. In the example of FIG. 6, as the attribute of the location where the facility is installed, the facility A is the building 1 and the first floor. As an attribute such as a step, the facility A is a step 1. In addition, industrial equipment. Although there is an attribute desired to be arbitrarily created and managed such as the importance of the production of industrial equipment and the part and the importance of the cost, the description is omitted in FIG. 6. These free tags are associated with a facility (equipment), a plant, an equipment (machine), a part constituting these, and the like.

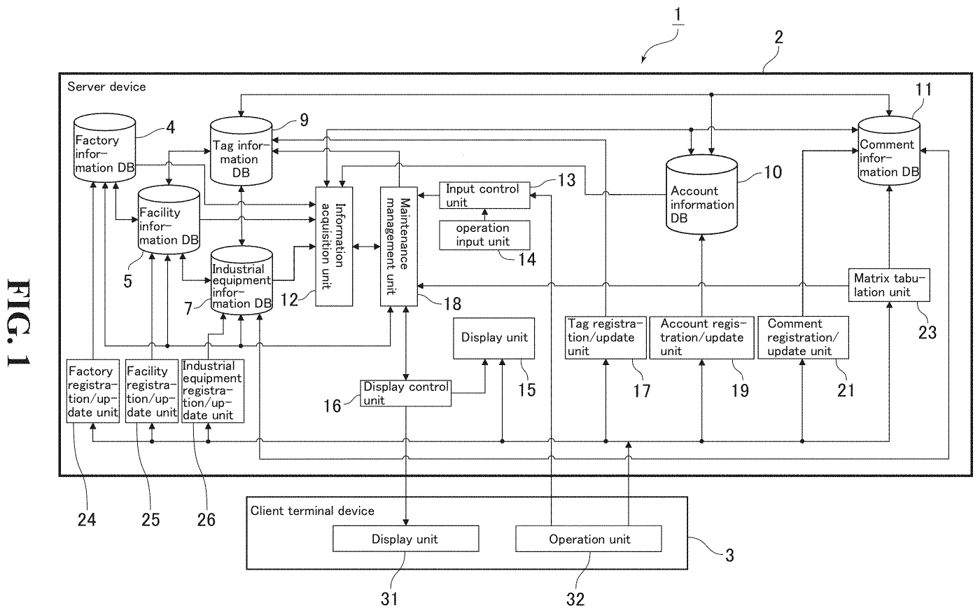

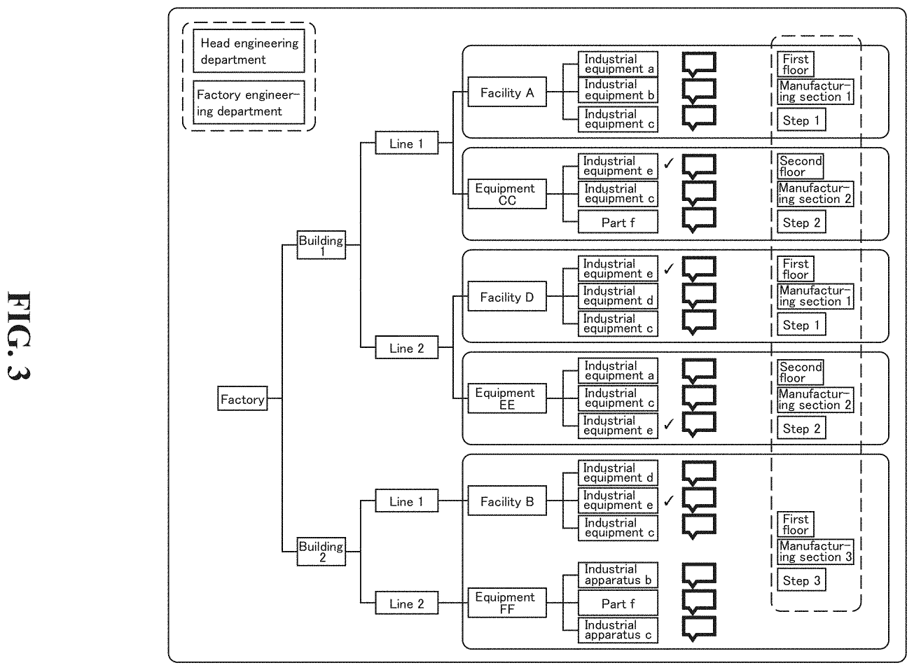

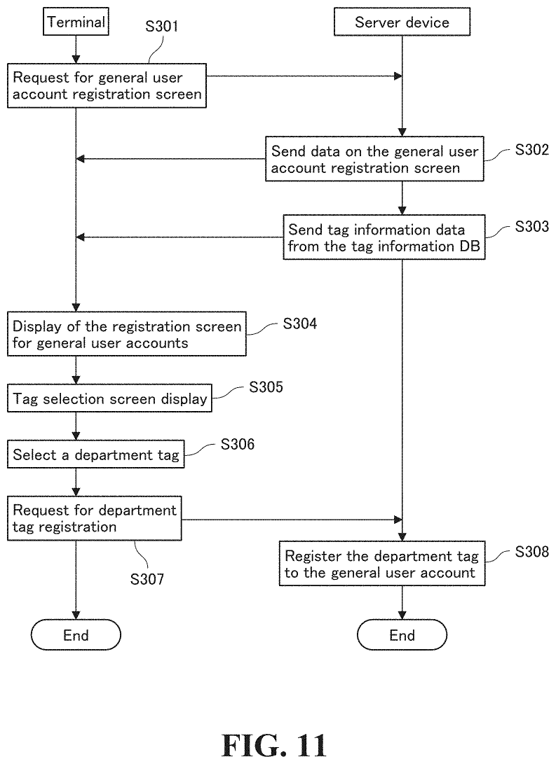

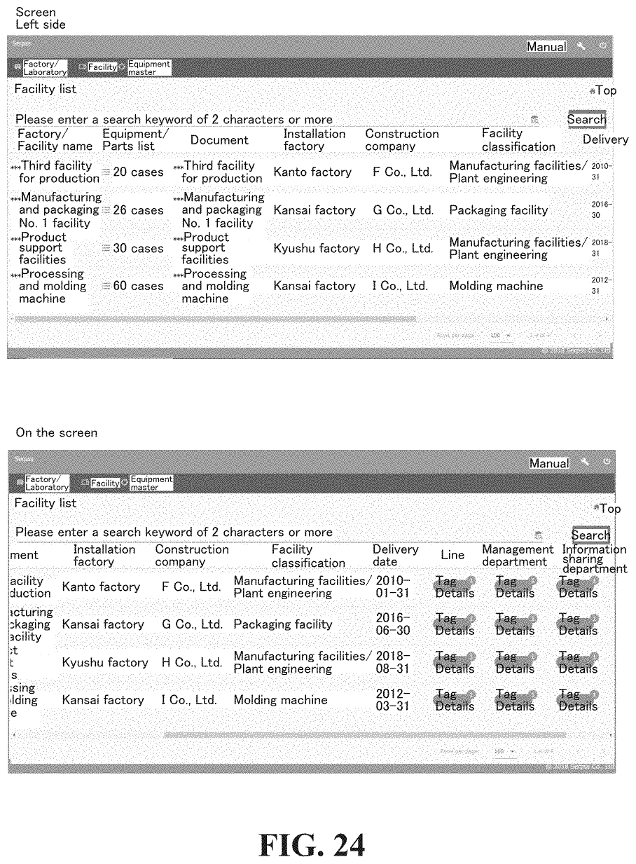

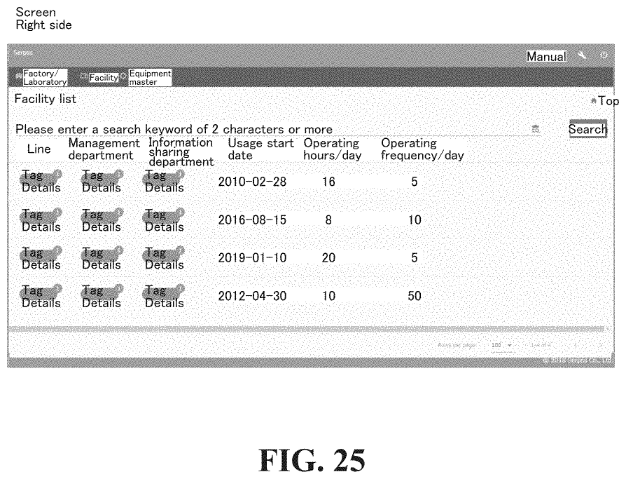

Hereinafter, a maintenance information management system according to an embodiment of the present invention will be described with reference to FIGS. 1 to 39.

In FIG. 1, a maintenance information management system 1 according to an embodiment of the present invention manages and provides maintenance information collected with respect to a facility, for example, a manufacturing facility. The maintenance information management system 1 includes a server device 2 and a client terminal device 3.

### Client Terminal Device

The client terminal device 3 is a general computer having a function realized by including hardware such as a display unit 31 composed of a liquid crystal display, a keyboard, a mouse, or the like, an input control unit (not shown), a drawing processing unit (not shown), and the like, and functions as a part of the maintenance information management system 1 by executing a management program (installed) recorded in a memory (not shown) by a computer (a processor such as a CPU) (not shown), a register for storing instructions and information, a peripheral circuit, and the like.

When the maintenance information management system 1 is used, the management program is activated, and each function of the input control unit, the display unit 31, the communication processing unit, and the drawing processing unit is used.

When, for example, a touch panel is used as the display unit 31, the touch panel combines a display device such as a liquid crystal panel and a position input device such as a touch pad, display various types of information by processing of the executed management program, and allows a user to input an operation by touching the screen with a fingertip or the like.

The client terminal device 3 is connected to the server device 2 by a LAN (Local Area Network) or the like, and has a function of selecting various items in various screens displayed on the display unit 31 to be described later by the operation unit 32, or inputting predetermined maintenance information to the maintenance information management system 1. It is to be noted that a plurality of client terminal device 3 can be connected to the server device 2 to be used.

In this case, the communication processing unit is configured to include various hardware for performing communication processing. For example, the communication processing unit is connected to a network via a network such as the Internet using Wi-Fi, and transmits and receives information to and from an external device including the server device 2 on the basis of a function realized by various applications.

### Server Device

The server device 2 is a general computer including a CPU, a memory, a hard disk drive, a communication interface circuit, and the like. The server device 2 includes a factory information database (DB) 4, a facility information database (DB) 5, an industrial equipment information database (DB) 7, a tag information database (DB) 9, an account information database (DB) 10, an information acquisition unit 12, an input control unit 13, an operation input unit 14, a display unit (server side display unit) 15, a display control unit 16, and a tag registration/update unit (17) account registration/update unit 19 and comment registration/update unit 21, the matrix tabulation unit 23, and the factory registration/update unit 24 and facility registration update unit 25 and the industrial equipment registration/update unit 26. The information acquisition unit 12 corresponds to the first management target information acquisition unit and the second management target information acquisition unit according to claim 1.

### Various Databases

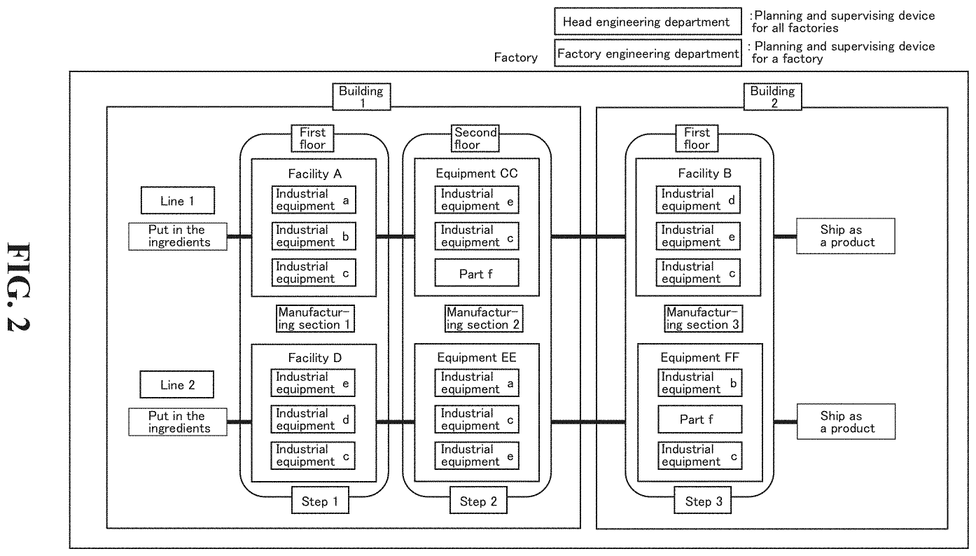

Information of a factory such as a factory name is registered in the factory information database 4, information of equipment such as a facility name is registered in the facility information database 5, and information of industrial equipment and part constituting equipment used in a factory is registered in the industrial equipment information database 7. In the facility information database 5, each facility in the factory is registered as shown in FIG. 2, and each of the industrial equipment and the part is registered in the industrial equipment information database 7. If it is unique, it is confirmed that an industrial equipment and a part are registered and it is only a name and a type In general, the industrial equipment is registered as long as it is a plant. If the industrial machine is an industrial machine, the industrial equipment and the part are registered.

Factory registration/the update unit 24 registers or updates the factory information or the factory update information input via the operation unit 32 on the client terminal device 3 side, which will be described later, in the factory information database 4. Facility registration/the update unit 25 registers or updates and registers the facility information or the facility update information input via the operation unit 32 on the client terminal device 3 side, which will be described later, of the employee in the facility information database 5. Industrial equipment registration/the update unit 26 registers or updates and registers the industrial equipment information or the industrial equipment update information input via the operation unit 32 on the client terminal device 3 side, which will be described later, of the employee in the industrial equipment information database 7.

As shown in FIG. 5, in the tag information database 9, information (tag information) of various attributes for each facility and each equipment in the factory is registered. For example, as shown in FIG. 5, for example, a line tag indicating a manufacturing line in which at least one of the each facility and at least one of the industrial equipment in the factory is disposed, a department tag used for an attribute related to a department such as an information sharing department for sharing management information, a facility classification tag indicating an attribute of the facility, an equipment classification tag indicating an attribute of the equipment, a free tag that a hierarchy in which equipment and industrial equipment are arranged, a building, a step and attributes are freely able to create, but the present invention is not limited thereto. Tag registration/update unit 17 registers or updates and registers the tag information or the tag update information input via the operation unit 32 of the employee in the tag information database 9.

The user account information (name, mail address, password, belonging department information, etc.) is registered in the account information database 10. Account registration/The update unit 19 registers or updates and registers the account information or the account update information input via the operation unit 32 of the employee in the account information database 10.

In the comment information database 11, an employee comment is registered for each industrial equipment registered in the industrial equipment information database 7, and the account information of the employee who has comment and the belonging department tag information associated with the employee are also registered in the comment information database 11. The comment is registered in the comment information database 11 after a comment is input to the comment input screen that has transitioned from an equipment list screen (equipment list page) to be described later. Comment registration/the update unit 21 registers or updates and registers comment information or comment update information input via the employee operation unit 32 in the comment information database 11.

The operation input unit 14 is composed of, for example, an input industrial equipment such as a keyboard, a touch pad, a touch panel, and a mouse. The operation input unit 14 receives an operation input from the user, and supplies information to be supplied to the maintenance management unit 18, the information acquisition unit 12, and the client terminal device 3 (instruction (instruction) or various data) to be supplied to the input control unit 13.

The input control unit 13 receives information input from the operation input unit 14 and information input from an operation unit 32 described later, and supplies the information to each unit of the maintenance information management system 1.

When the instruction output from the operation input unit 14 or the operation unit 32 is received via a maintenance management unit 18, which will be described later, the information acquisition unit 12 extracts management target information including factory information, facility information, industrial equipment information, tag information, account information, and comment information registered or updated and registered in the factory information database 4, the facility information database 5, the tag information database 9, the account information database 10, and the comment information database 11, and supplies the information to the maintenance management unit 18.

Here, the management target information is divided into first management target information and second management target information. The first management target information refers to a management target that is the management target information related to the management target present as a classification target and has only one classification item when the management target is classified by an arbitrary classification item, and is, for example, factory information (EX factory name), facility information (EX facility name), equipment information (EX equipment name, part name), comment information, and the like in the present embodiment

The second management target information refers to management target information having a plurality of so-called attribute items in which a plurality of classification items exist, and for example, in the present embodiment, tag information (for example, a line tag, a management department tag, an information sharing department tag, a facility classification tag, an equipment classification tag, and a free tag) correspond to each other.

The maintenance management unit 18 generates related maintenance management information (for example, information in which a line tag and a management department tag are associated with facility information) by associating the account information and the first management object information extracted via the information acquisition unit 12 with each of a plurality of classification items constituting the second management target information, and generates a registration page screen (facility list page, equipment list page screen, and document page screen) for inputting (registering) information necessary for newly generating the maintenance management information or updating the maintenance management information. The system has a function of storing the generated maintenance management information and various page screens. Then, the maintenance management information and the various page screens are supplied to the display control unit 16 on the basis of the user's operation input via the operation unit 32.

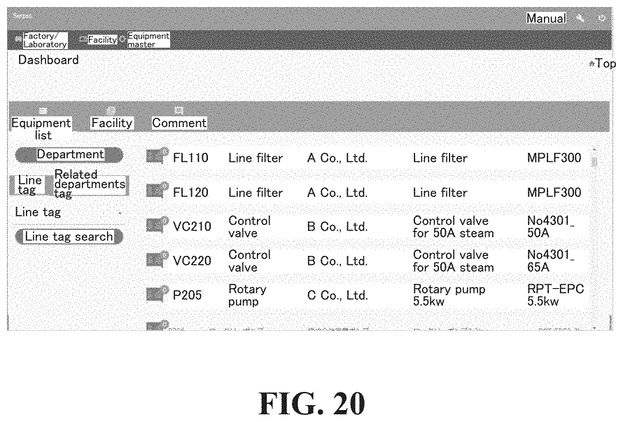

The display control unit 16 controls the display of the maintenance management information or controls the screen transition of various page screens. The display units 15 and 31 are configured by, for example, a display device such as a liquid crystal display and a touch panel, and display maintenance management information in which a line tag and a management department tag are associated with facility information, and various registered page screens based on the control of the display control unit 16 The display screen displayed on the display unit 15 includes, for example, a large facility list screen (left block), an equipment list screen (central block), and an equipment master screen (right block) as shown in FIG. 5, and, for example, when the industrial equipment is selected, each management information is aggregated into the industrial equipment master page and managed as one source. In the integrated search screen of FIG. 20, the facility A, the equipment CC, and the equipment list of the facility B are collectively displayed on the integrated search screen when the line 1 is to be extracted. The details will be described later. The industrial equipment master screen can perform manufacturer name identification processing (manufacturer identity verification processing), product name identification processing, and type name identification processing, and details will be described later.

The matrix tabulation unit 23 performs determination processing on attributes of comments such as periodic inspection, periodic replacement, abnormality occurrence, investigation, conclusion, and others on the basis of determination criteria such as the number of elapsed days, the operation time, and the number of times of operation on the equipment or parts selected on the industrial equipment master screen, and supplies the determination result to the comment information database 11 and the maintenance management unit 18. The maintenance management unit 18 supplies, to the display control unit 16, a comment icon indicating a comment associated with an arbitrary attribute such as periodic inspection, periodic replacement, abnormality occurrence, investigation, conclusion, and others on the basis of the determination result determined by the matrix tabulation unit 23, and the display control unit 16 controls the display units 15 and 31 so as to cause the display unit 15, 31 to display the display icon on the industrial equipment master screen described later.

### Flow of Processing of System

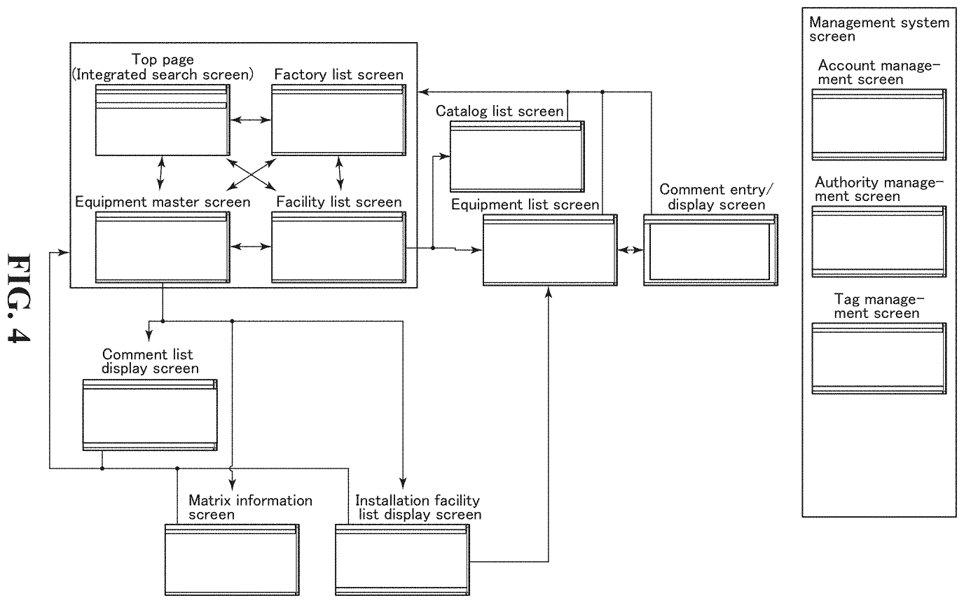

Next, the flow of the process of the maintenance information management system 1 according to the present embodiment will be described with reference to FIGS. 4 to 38.

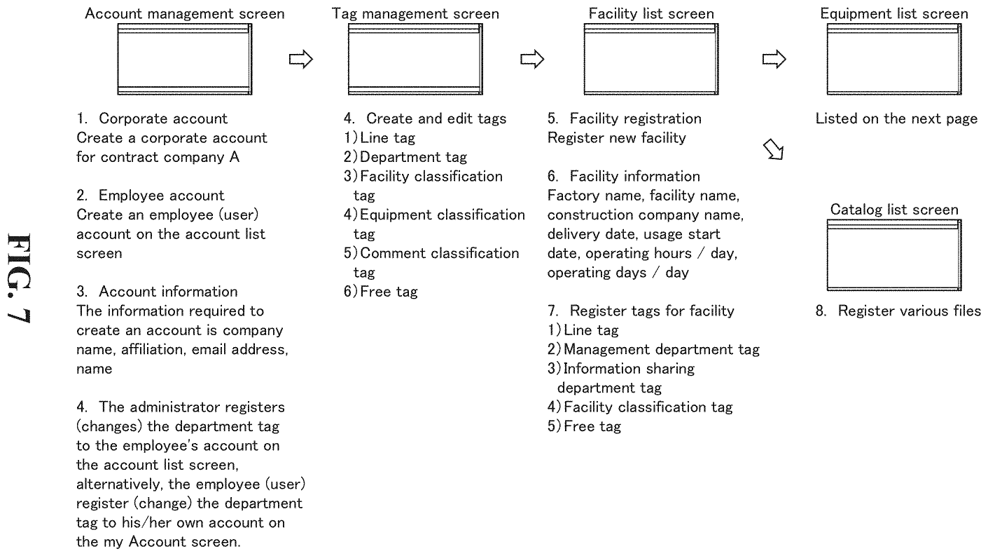

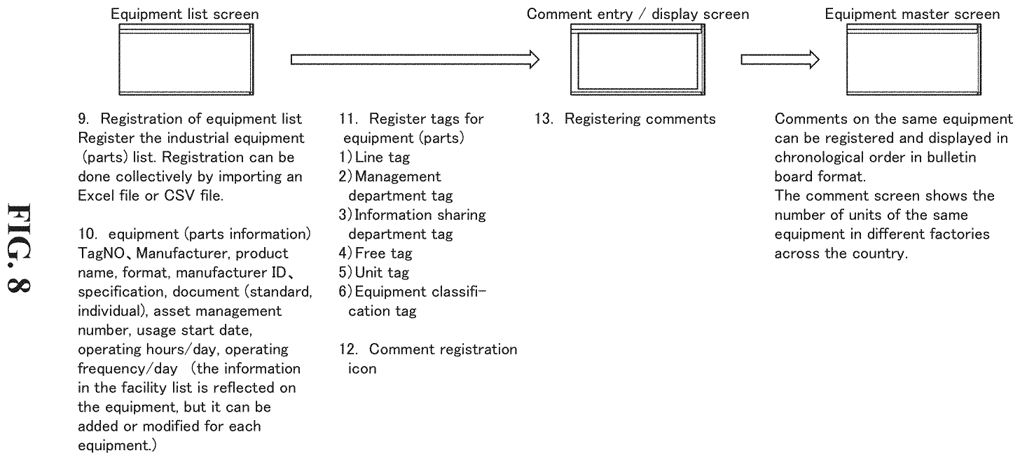

First, the overall flow of each process of the maintenance information management system 1 according to the present embodiment will be described with reference to FIG. 4, FIG. 7, and FIG. 8.

As shown in FIG. 4, the maintenance information management system and the screen (page) transition are configured such that the integrated search screen (top page), the industrial equipment master screen, the facility list screen, and the factory list screen can mutually transition and can transition from all the screens to the four screens. From the facility list screen, the industrial equipment list screen and the completed book (catalog list) screen can be changed, and a comment list display screen, a matrix information screen, and an installation facility list page can be shifted from the industrial equipment master screen. Comment entry from equipment list screen. A transition can be made to the display screen. In addition to the above-described respective screens, there is also a management system screen composed of an account management screen, an authority management screen, and a tag management screen.

Hereinafter, the account management screen, the tag management screen, the facility list screen, the equipment list screen, the catalog list screen, and the comment entry. The processing on each screen is described in the order of screen transition of the display screen and the industrial equipment master screen with reference to the drawings.

### Account Information Registration Process

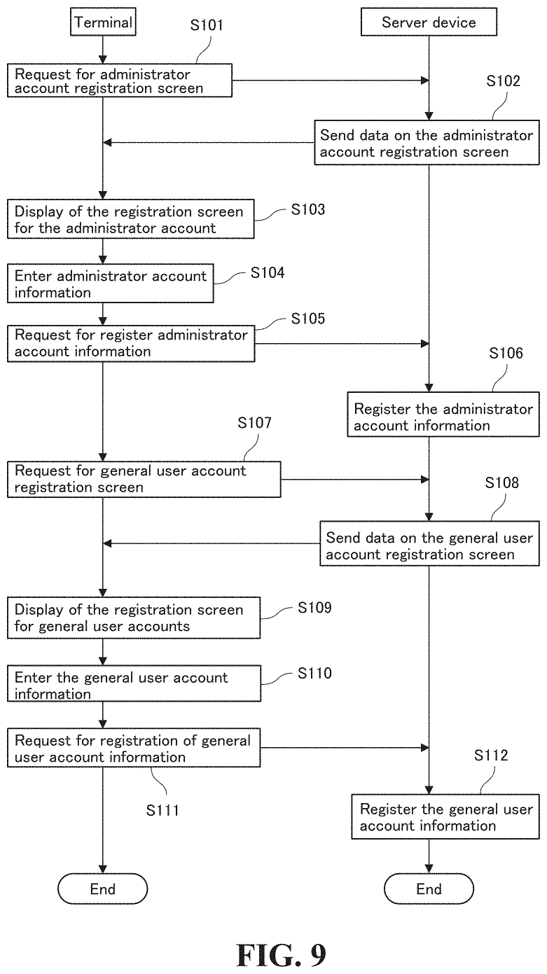

Hereinafter, the account information registration process will be described with reference to FIGS. 7 and 9. Note that the account includes a user count and a company account, the user count is a manager account and a general user count, in principle, the user count is created by the operation unit 32 of the client terminal device 3, and the company account is created on the server device 2 side. Here, the information of the administrator account is an account, a name, a mail address, and the like of the manager account, and the general user count can be created, and the general user count information is a belonging, name, mail address, and the like of the general user count, and the information of the company account is the name of the company using the system or the like. It is needless to say that account information registration processing can be performed even in a plurality of cases.

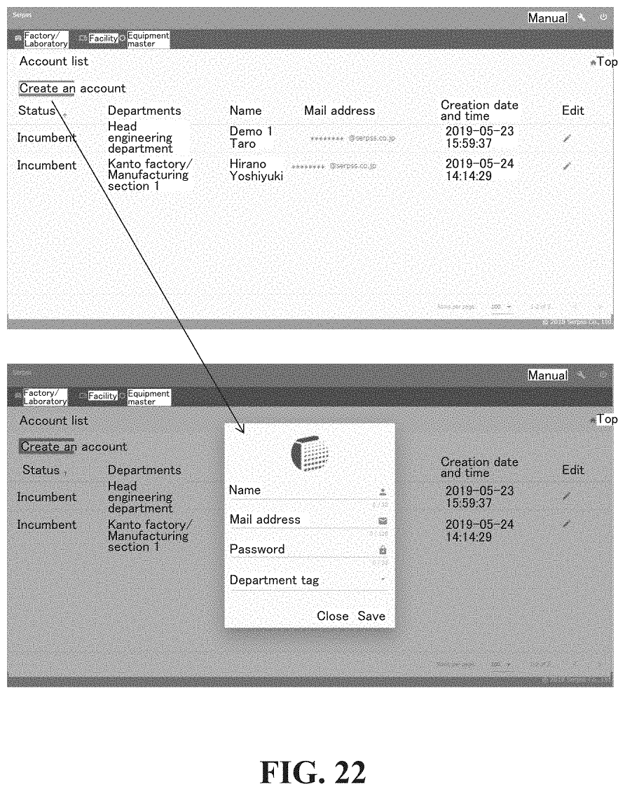

The manager account registration screen request (refer to the upper diagram account creation button in FIG. 22) from the operation unit 32 is supplied to the maintenance management unit 18 via the information acquisition unit 12 of the server device 2, and the following “supply” is used in the meaning of “transmission”. In step S 101, the maintenance management unit 18 transmits the manager account registration screen data (step S 102). A registration screen (see FIG. 22 in FIG. 22) related to the administrator account is displayed on the display unit 31 of the client terminal device 3 (step S 103) when the manager account information is input via the operation unit 32 (step S 104 and FIG. 22), the registration request of the administrator account information is supplied to the maintenance management unit 18 (step S 105), and the maintenance management unit 18 stores the administrator account information in the account information DB 10 and registers the administrator account information (step S 106).

When the general user count registration screen request is supplied to the maintenance management unit 18 (step S107), the maintenance management unit 18 transmits general user count registration screen data (step S108). A registration screen related to the general user count is displayed on the display unit 31 (step S 109). When the general user count information is input via the operation unit 32 and the registration request of the general user count information is supplied to the maintenance management unit 18 (step S 111), the maintenance management unit 18 stores the general user count information in the account information DB 10 and registers the manager account information (step S 112).

The company account information is displayed on the display unit 15 via the operation input unit 14 and the maintenance management unit 18 of the server device 2. Note that the manager account and the department tagging to the general user count are registered in the account list screen (see the column of the upper diagram of FIG. 22), the account registration screen (refer to the lower FIG. department tag of FIG. 22), and the my account screen. Although not shown, the account screen is a screen on which only the account information created in the account list of the user of the user is displayed.

### Tag Information Registration Process

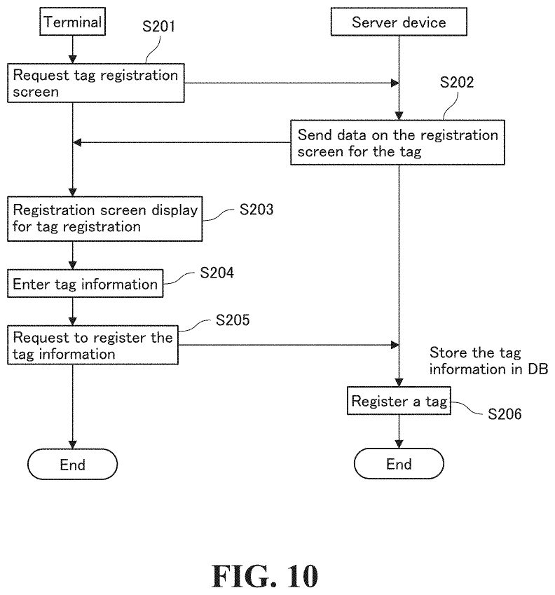

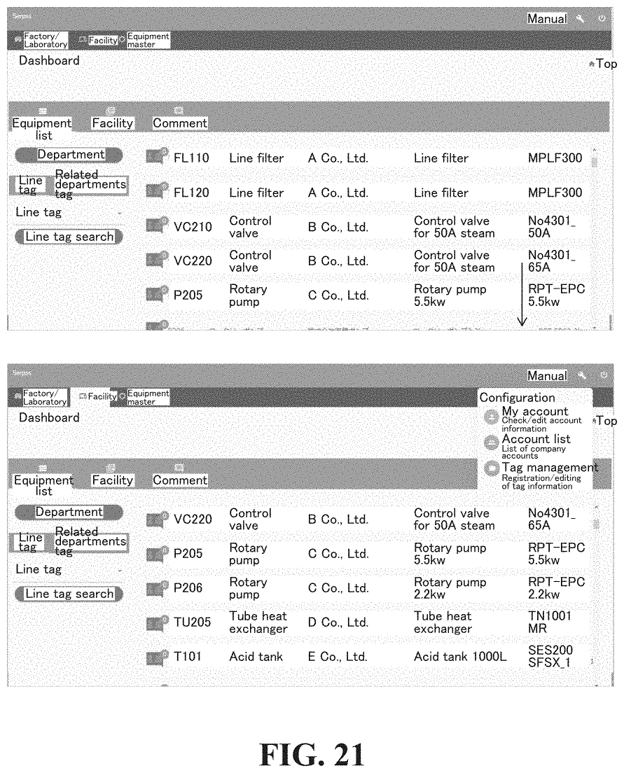

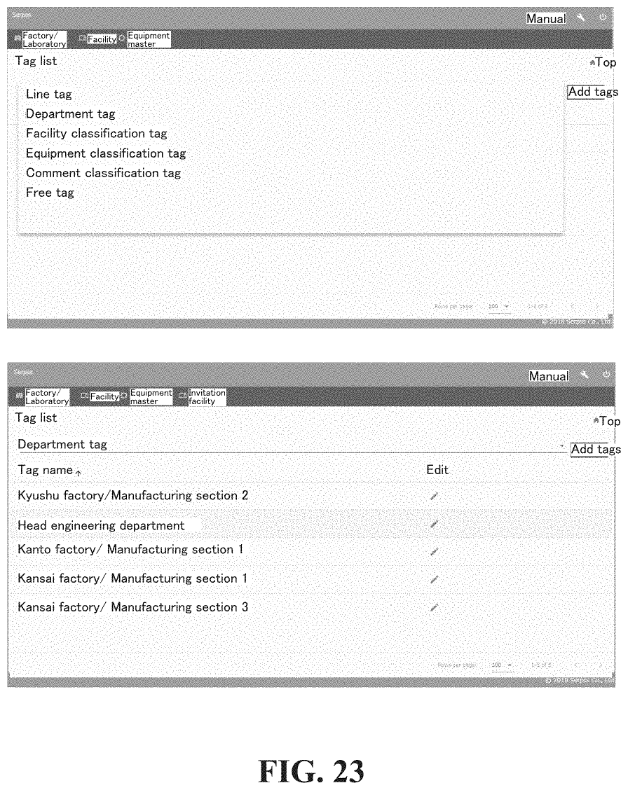

The tag information registration process will be described below with reference to FIG. 7, FIG. 10, FIG. 21, and FIG. 23. When the tag registration screen request is supplied from the operation unit 32 to the maintenance management unit 18 via the information acquisition unit 12 of the server device 2 (step S 201, FIG. 21), the maintenance management unit 18 transmits the tag registration screen data (step S 202). A tag registration screen (see FIG. 23) is displayed on the display unit 31 of the client terminal device 3 (see FIG. 23) (step S 203) when the tag information is input via the operation unit 32 (step S 204), the registration request of the tag information is supplied to the maintenance management unit 18 (step S 205), and the maintenance management unit 18 stores the tag information in the tag information DB 9 and registers the tag information (step S 206). Examples of the tag information include a line tag, a department tag, a facility classification tag, a free tag, a unit tag, an equipment classification tag, and a comment tag. Although not shown, the unit tag is obtained by tagging the name of a unit or section which is a unit in which an equipment and a part are arbitrarily combined.

### Process for Associating Department Tag Belonging to General User Count Information

Referring to FIGS. 7,11,21, and 22, a description is given of processing for associating the manager account with the general user count information with the department tag belonging to the general user count information. The general user count registration screen request is supplied from the operation unit 32 to the maintenance management unit 18 via the information acquisition unit 12 of the server device 2 (step S 301, lower drawing account list button in FIG. 21), and the maintenance management unit 18 supplies general user count registration screen data (step S 302), and supplies the tag information data from the tag information DB 9 (step S 303). The display unit 31 of the client terminal device 3 displays a general user count registration screen and a belonging department tag registration screen (see FIG. 22 and FIG. 22) (steps S 304 and S 305). In step S 307, the belonging department tag information associated with the general user count information via the operation unit 32 is selected (step S 306), and the registration request of the selected belonging department tag information is supplied to the maintenance management unit 18 (step S 307) The maintenance management unit 18 stores (registers) the belonging department tag information in the tag information DB 9, and ends the association of the belonging department tag information with respect to the general user count (step S 308). The process of associating the department tag belonging to the administrator is also performed in the same procedure. The general user count itself can change the department tag belonging to the account screen.

### Processing for Registering Factory Information

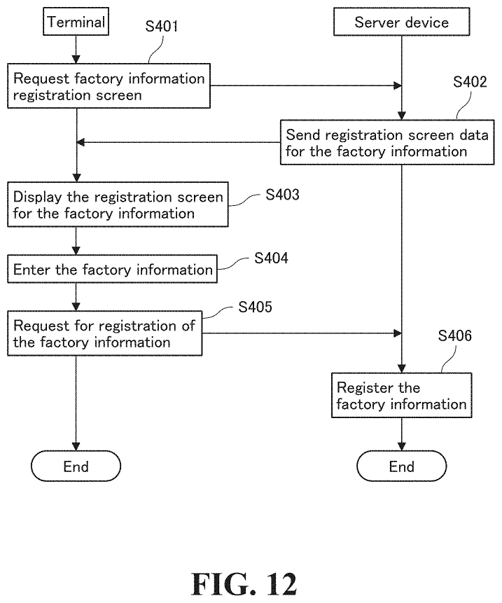

A factory information registration process will be described below with reference to FIG. 12. When the factory information registration screen request is supplied from the operation unit 32 to the maintenance management unit 18 via the information acquisition unit 12 of the server device 2 (step S 401), the maintenance management unit 18 transmits the factory information registration screen data (step S 402). A factory information registration screen (not shown) is displayed on the display unit 31 of the client terminal device 3 (step S 403). In step S 405, the factory information is input via the operation unit 32 (step S 404), and the registration request of the factory information is supplied to the maintenance management unit 18 (step S 405), and the maintenance management unit 18 stores the factory information in the factory information DB 4 and registers the factory information (step S 406). Although the factory information registration screen is not shown, the screen configuration includes a factory registration button, a factory name displayed when a button is pressed, a factory location, a table having a telephone number that can be added arbitrarily as a registration item, and a screen having a storage button.

Processing for Registering Facility Information and Associating Tag Information with Facility Information

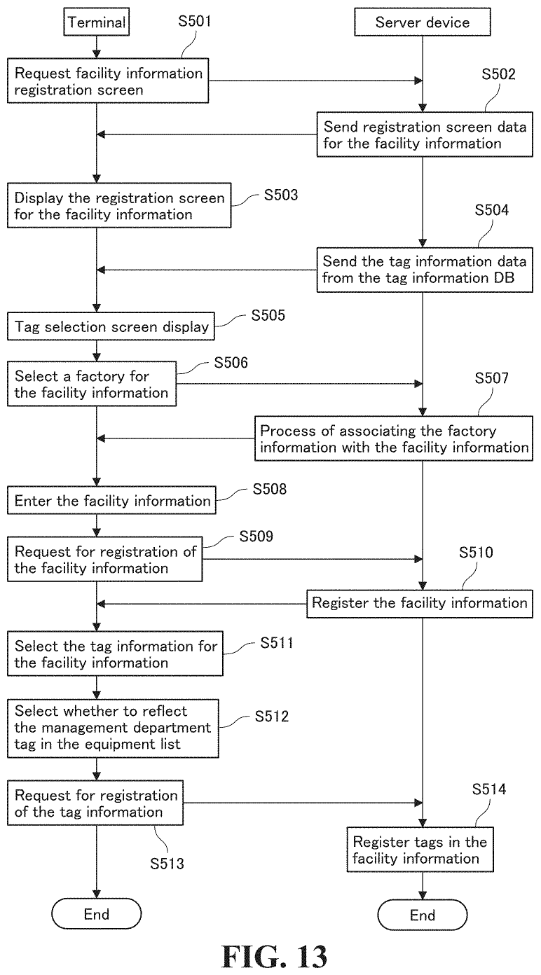

Hereinafter, processing for associating the tag information with the facility information will be described with reference to FIG. 13. When the facility information registration screen request is supplied from the operation unit 32 to the maintenance management unit 18 via the information acquisition unit 12 of the server device 2 (step S 501), the maintenance management unit 18 supplies the facility information registration screen data from the facility information DB 5 and the tag information data from the tag information DB 9 to the display unit 31 (steps S 502 and S 504). A facility information registration screen is displayed on the display unit 31 of the client terminal device 3 (step S 503), and a tag selection screen is displayed in the facility information registration screen (step S 505). When factory information corresponding to each facility information is selected via the operation unit 32 (step S506), the maintenance management unit 18 receives the selected factory information to associate the factory information corresponding to the facility information (step S507), and stores (registers) the associated facility information in the facility information DB 5. Although the facility information registration screen is not shown, the screen configuration includes a facility registration button, a table having facility information to be displayed as a registration item and displayed when a button is pressed, and a screen having a storage button.

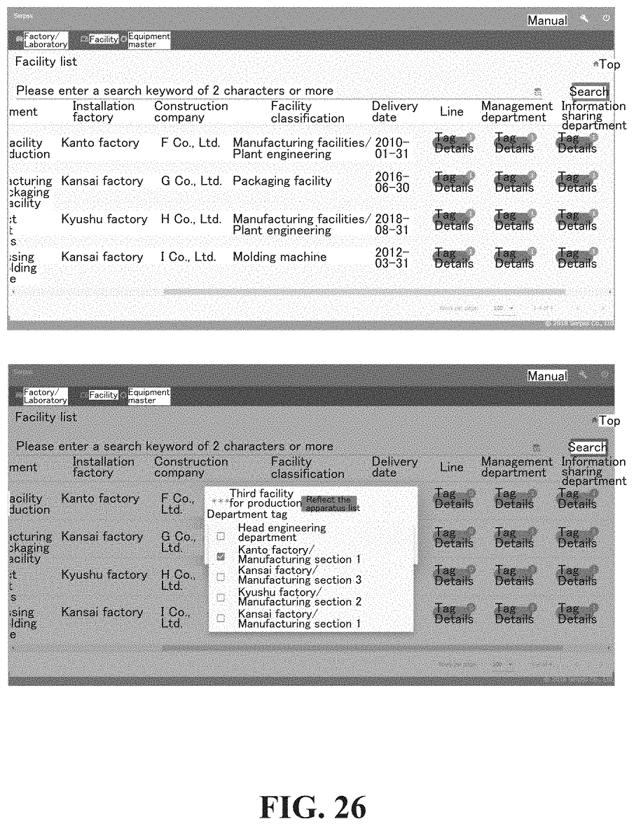

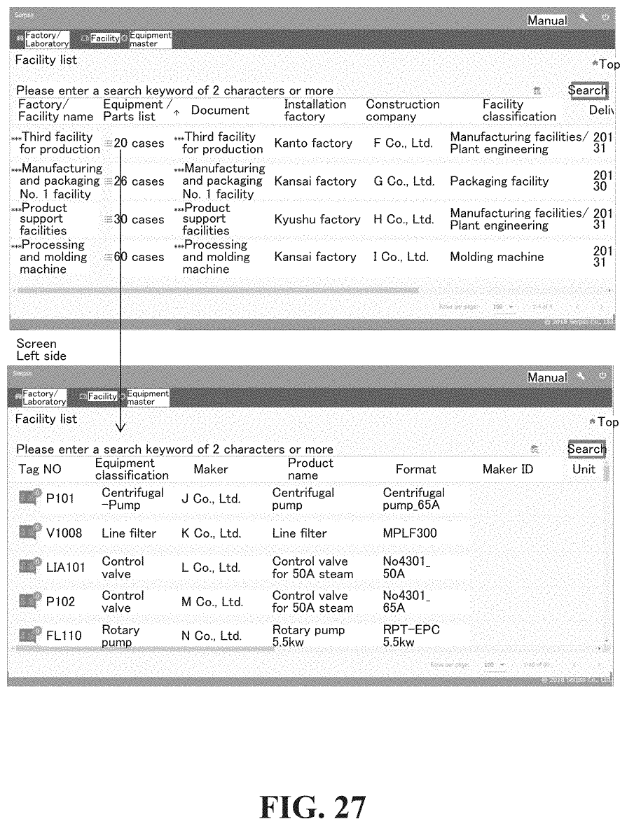

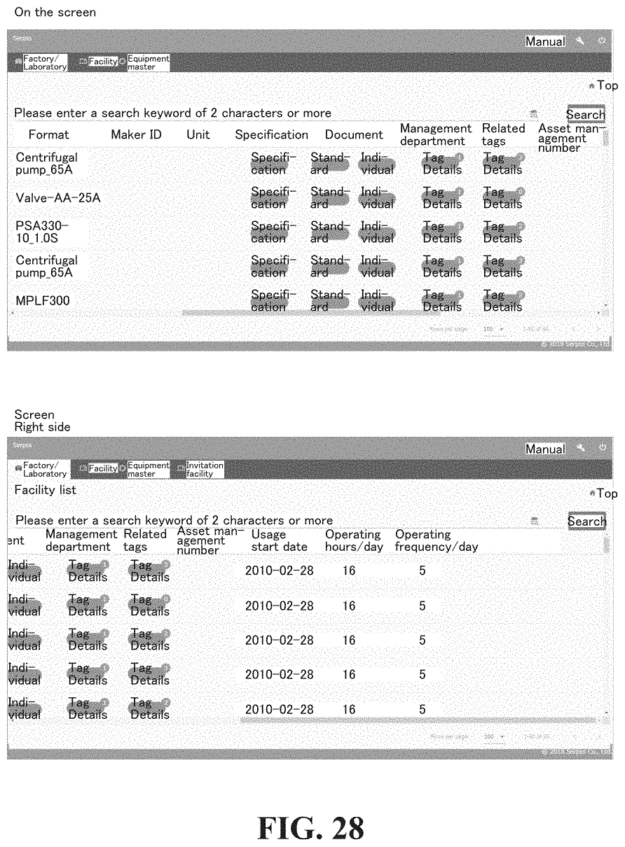

Thereafter, the facility information is input via the operation unit 32 (step S 508), and the registration request of the facility information is supplied to the maintenance management unit 18 (step S 509). Here, the input facility information is a facility name, a document name, an installation factory, a construction company, a delivery date, a model name, a model name, a production number, a use start date, an operation time/date, an operation number/day, and the installation factory selects a factory registered in the factory information DB 4. The maintenance management unit 18 stores the facility information in the facility information DB 5 and registers the facility information (step S 510). Thereafter, tag information to be associated with the registered facility information via the operation unit 32 is selected (refer to step S 511 and a screen displaying a column of the upper diagram line, the management department, and the information sharing department tag in FIG. 26), for example, a line tag, an information sharing department tag, a facility classification tag, and a free tag) are reflected on an equipment list (see FIG. 27, FIG. 28) to be described later (step S 512, and FIG. 26). The registration request or the like of the selected tag information is supplied to the maintenance management unit 18 (step S 513), and the maintenance management unit 18 stores (registers) the tag information in association with the facility information in the facility information DB 5 (step S 514).

Processing for Registering Industrial Equipment Information and Associating Tag Information with Industrial Equipment Information

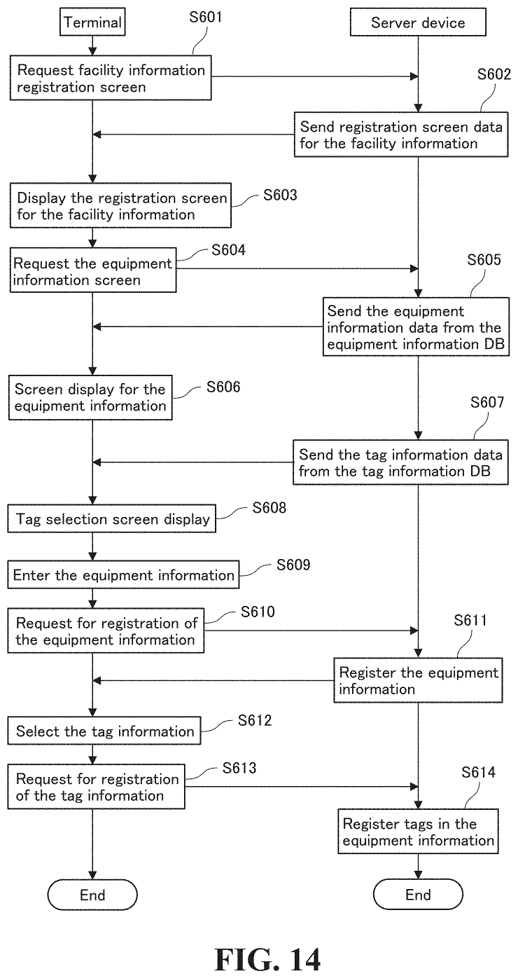

Hereinafter, the equipment information (equipment list) is registered with reference to FIG. 8, FIG. 14, and the like, and processing for associating the tag information with the equipment information will be described. When the facility information registration screen request is supplied from the operation unit 32 to the maintenance management unit 18 via the information acquisition unit 12 of the server device 2 (step S 601), the maintenance management unit 18 supplies the facility information registration screen data from the facility information DB 5 to the display unit 31 (step S 602). A facility information registration screen is displayed on the display unit 31 of the client terminal device 3 (step S 603), and the industrial equipment information screen request is supplied from the operation unit 32 to the maintenance management unit 18 via the information acquisition unit 12 of the server device 2 (step S 604 and FIG. 27). When the number of part is clicked by 20 or the like of the part list column, the number of pieces of equipment is displayed. The maintenance management unit 18 supplies the industrial equipment information screen data from the industrial equipment information DB 7 and the tag information data from the tag information DB 9 to the display unit 31 (steps S 605 and S 607). Although the industrial equipment information registration screen is not shown, the screen configuration includes a display unit for importing an exercise cell or a CSV file, a display unit for making a column of the industrial equipment list screen (see FIG. 27 and FIG. 28) correspond to the column of each table, and a storage button.

The display unit 31 of the client terminal device 3 displays an equipment information screen (see FIG. 27, FIG. 28, and FIG. 28) (step S 606), and a tag selection screen is displayed in the industrial equipment information screen (step S 608, FIG. 28). The equipment information is input via the operation unit 32 (step S 609), and the registration request of the industrial equipment information is supplied to the maintenance management unit 18 (step S 610) Here, the input industrial equipment information is a Tag number (Tag No), a manufacturer name, a product name, a model (part number), a manufacturer ID, a specification, a document (standard, individual), an asset management number, a use start date, an operation time/date, an operation time/date, a maker ID, a manufacturer ID, and specification information can be rewritten by name identification. Note that although the information on the facility list is also reflected on the industrial equipment, it is possible to add and correct the information on the industrial equipment alone.

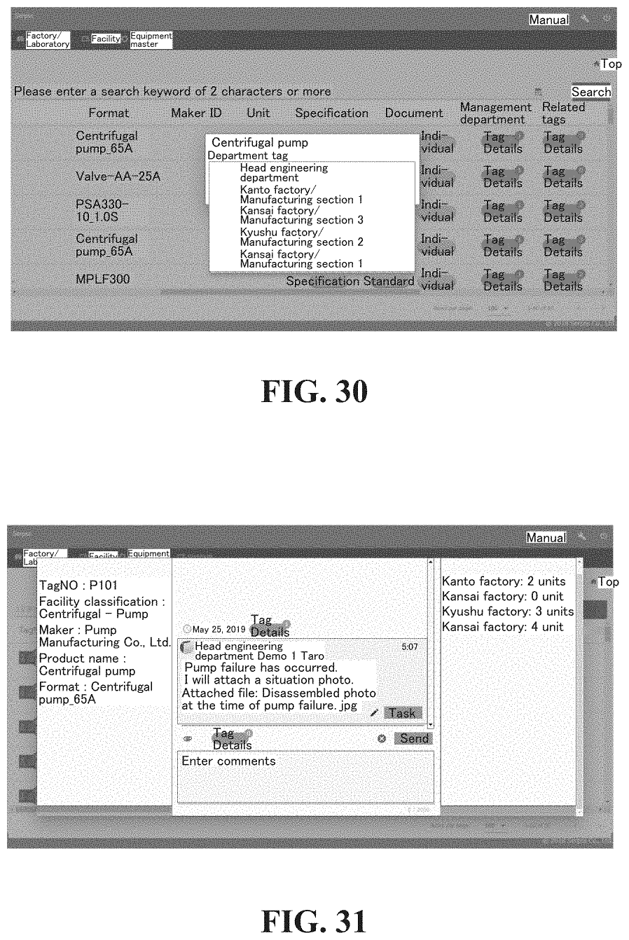

Thereafter, the maintenance management unit 18 stores (registers) the industrial equipment information in the industrial equipment information DB 7 (step S 611). After registration into the industrial equipment information DB 7 of the equipment information, tag information to be associated with each piece of equipment information is selected via the operation unit 32 (step S 612, see FIG. 30 (type at the top of the list is selected to the management department tag unit for the industrial equipment of centrifugal pump 65A)), and the registration request of the selected tag information is supplied to the maintenance management unit 18 (step S 613), and the maintenance management unit 18 stores (registers) the tag information in association with the industrial equipment information in the industrial equipment information DB 7 (step S 614).

Processing for Registering Comment Information and Associating Tag Information with Comment Information

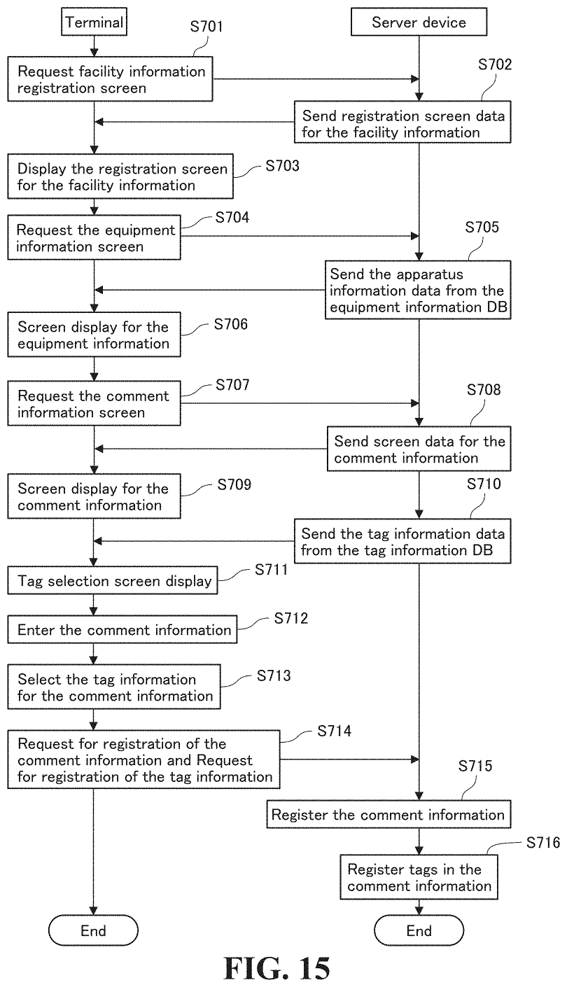

Hereinafter, the comment information is registered with reference to FIG. 8 and FIG. 15, and processing for associating the tag information with the comment information will be described. When the facility information registration screen request is supplied from the operation unit 32 to the maintenance management unit 18 via the information acquisition unit 12 of the server device 2 (step S 701), the maintenance management unit 18 supplies the facility information registration screen data from the facility information DB 5 to the display unit 31 (step S 702). A facility information registration screen (not shown) is displayed on the display unit 31 of the client terminal device 3 (step S 703), and the industrial equipment information screen request is supplied from the operation unit 32 to the maintenance management unit 18 via the information acquisition unit 12 of the server device 2 (step S 704 and FIG. 27). The maintenance management unit 18 supplies the industrial equipment information screen data from the industrial equipment information DB 7 to the display unit 31 (step S 705). The display unit 31 of the client terminal device 3 displays an equipment information screen (see FIG. 27, FIG. 28, and FIG. 28) (step S 706). Next, the screen display request related to the comment information from the operation unit 32 is supplied to the maintenance management unit 18 via the information acquisition unit 12 of the server device 2 (step S 707), and the maintenance management unit 18 supplies the screen data related to the comment information from the comment information DB 11 and the tag information data from the tag information DB 9 to the display unit 31 (steps S 708 and S 710). The maintenance management unit 18 supplies the comment information screen data from the comment information DB 11 and the tag information data from the tag information DB 9 to the display unit 31 (steps S 709 and S 711).

The display unit 31 of the client terminal device 3 is provided with a comment information screen (see FIG. 27). FIG. 31 is a screen in which the comment and the comment tag are registered with respect to the tag No P101 and the product name centrifugal pump, and the screen before the comment registration is displayed (step S709), and the tag selection screen is displayed by pressing the tag detailed button in the comment information screen (step S711). A plurality of comment classification tags may be displayed in advance in the comment information screen and selected. The comment information is input via the operation unit 32 (step S 712), and then tag information to be associated with the input comment information is selected (step 713), and the input comment information and the selected tag information registration request are supplied to the maintenance management unit 18 (step S 714).

The maintenance management unit 18 stores (registers) the tag information in association with the comment information in the comment information DB 11 (step S 715), and registers the tag in the comment information (step S 716). The tag information to be selected is a periodic inspection, a periodic replacement, an abnormality occurrence, an investigation, a conclusion, and other (optionally created tags), and the comment registration processing is performed by operating in the order of “comment entry”→“tag selection”→“pressing a comment posting button”. However, the order of “comment entry”→“tag selection” may be reversed.

### Process for Extracting Comments for all Factories for Selected Equipment

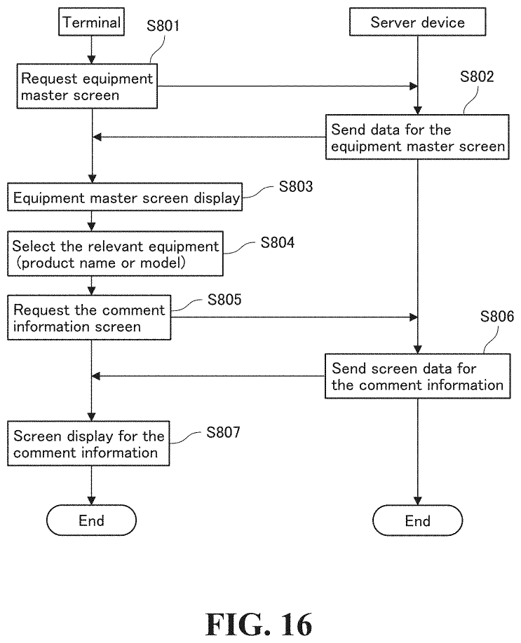

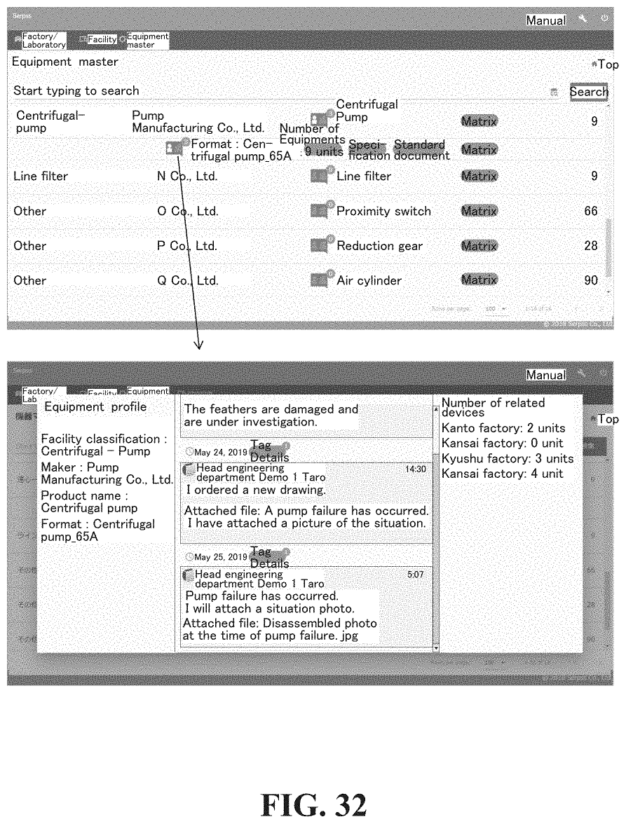

Hereinafter, a process of extracting a comment for all the factories with respect to the selected equipment with reference to FIG. 16 will be described. When the industrial equipment master screen request is supplied from the operation unit 32 to the maintenance management unit 18 via the information acquisition unit 12 of the server device 2 (step S 801), the maintenance management unit 18 transmits the industrial equipment master screen data (step S 802). An industrial equipment master screen (see FIG. 32 on FIG. 32) is displayed on the display unit 31 of the client terminal device 3 (step S 803), and FIG. 32 is a screen in which the product name centrifugal pump is selected and the model is developed. Selection of the corresponding industrial equipment (product name or model) via the operation unit 32 (step S 804, upper diagram reference type in FIG. 32): When the screen request related to the comment information is supplied to the maintenance management unit 18 after transition (step S 805), the maintenance management unit 18 supplies the screen data related to the comment information from the comment information DB 11 to the display unit 31 (step S 806), and the display unit 31 displays a screen related to the comment information (step S 807 and FIG. 32). By the above processing, it is possible to refer to a comment of all companies associated with an industrial equipment selected when a user wants to know a comment of all companies.

### Processing for Displaying Matrix Information Screen

The matrix information screen is organized according to a condition of a comment registered comment entry date information, tag information (comment tag: periodic inspection, periodic replacement, abnormality occurrence, investigation, conclusion, etc.), a number of comments, a determination criterion (the number of elapsed days, the number of operation times, the number of operation times), a determination span (for example, 30 days to 3 years, for example, 30 days to 3 years). For example, the equipment has a function of making a determination assist for optimizing the period of maintenance by making a period in which an abnormality occurs in the equipment visible, for example.

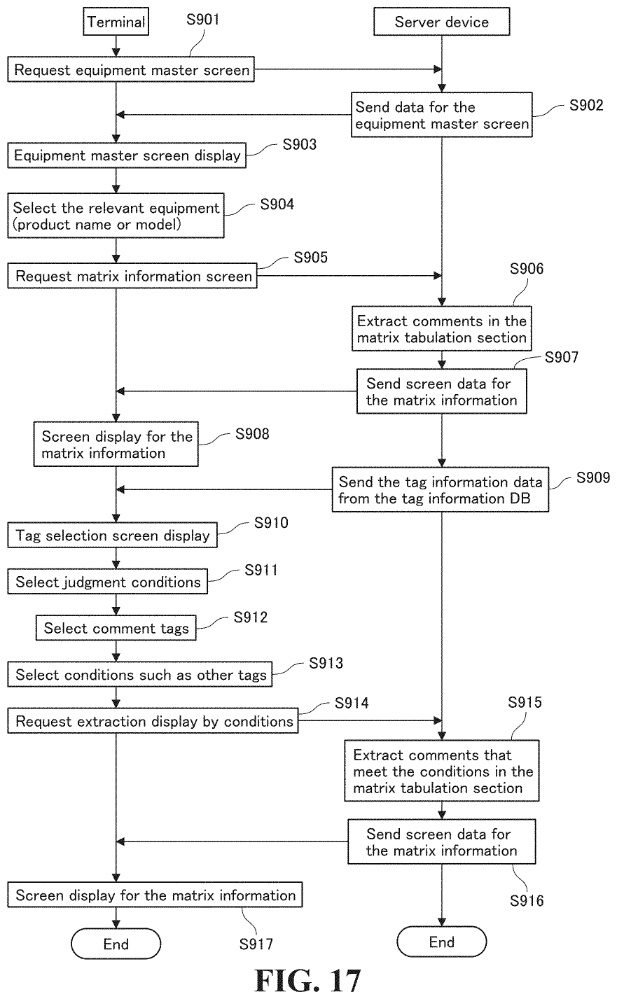

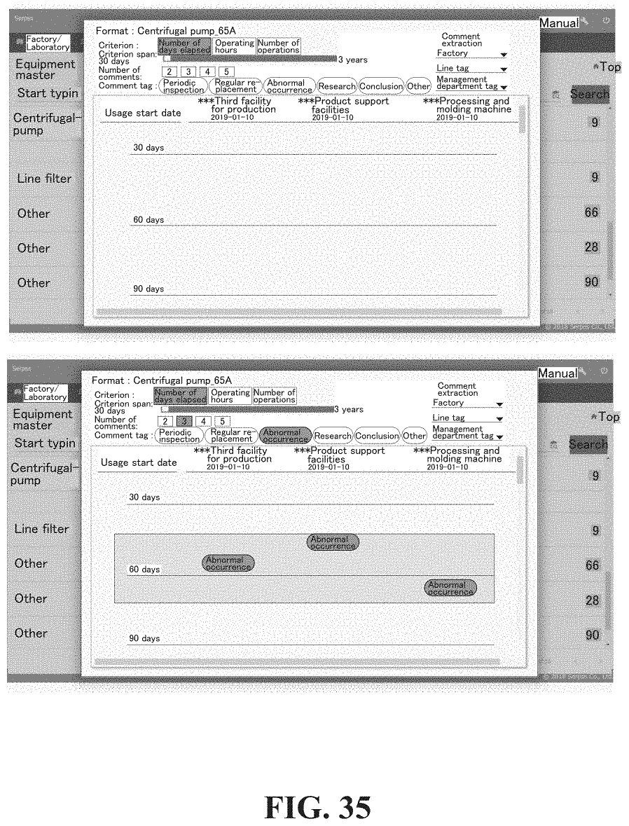

Hereinafter, a process of displaying the matrix information screen will be described with reference to FIG. 17. Here, the matrix information is extracted by designating a range to extract or extract comment information in the type of a product or a product which is a product or a product, and the extracted comment information is extracted by an arbitrary tag given to the comment, and the selected determination criterion (determination criterion is shown in FIGS. 35 and 35: the number of elapsed days, the operation time, and the number of operation times), and the matrix information screen is a screen on which the matrix information is displayed (see FIG. 35).

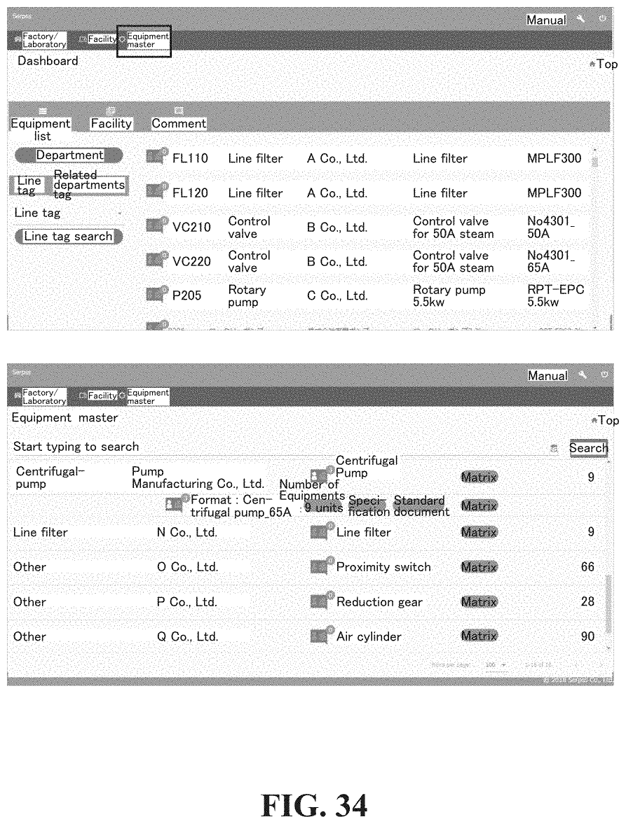

When the industrial equipment master screen request is supplied from the operation unit 32 to the maintenance management unit 18 via the information acquisition unit 12 of the server device 2 (step S 901 and below chart in FIG. 34), the maintenance management unit 18 transmits the industrial equipment master screen data (step S 902). An industrial equipment master screen (see below chart in FIG. 34) is displayed on the display unit 31 of the client terminal device 3 (step S 903). After selection of the corresponding industrial equipment (product name or model) via the operation unit 32 (step S 904, type at below chart in FIG. 34 is selected to centrifugal pump 65A) is performed, the matrix information screen request (for example, the matrix icon of the lower drawing in FIG. 34) is supplied to the maintenance management unit 18 (step S 905, see below chart in FIG. 34), and the maintenance management unit 18 extracts the comment information from the comment information DB 11 with respect to the matrix tabulation unit 23 (step S 906). The tag information data from the tag information DB 9 and the factory information data from the factory information DB 4 are supplied to the display unit 31 (steps S 907 and S 909), and the display unit 31 displays a screen related to the matrix information and a tag selection screen (steps S 908 and S 910, see FIG. 35 and above chart thereof).

Next, conditions such as determination conditions, comment tags, other tags, factories, and the like are selected via the operation unit 32 (Steps S 911, S 912, S 913, and FIG. 35), and thereafter, the display request of the extraction result based on the selected condition is performed to the maintenance management unit 18 (step S 914, and FIG. 35 is a state in which the result is already displayed). The maintenance management unit 18 extracts comment information conforming to the condition with respect to the matrix tabulation unit 23 (step S 915), and supplies the screen data related to the matrix information including the comment information extracted to the display unit 31 to the display unit 31 (step S 916). The display unit 31 displays a screen (see FIG. 35) related to the matrix information (step S 917).

### Process for Displaying Department Information Screen

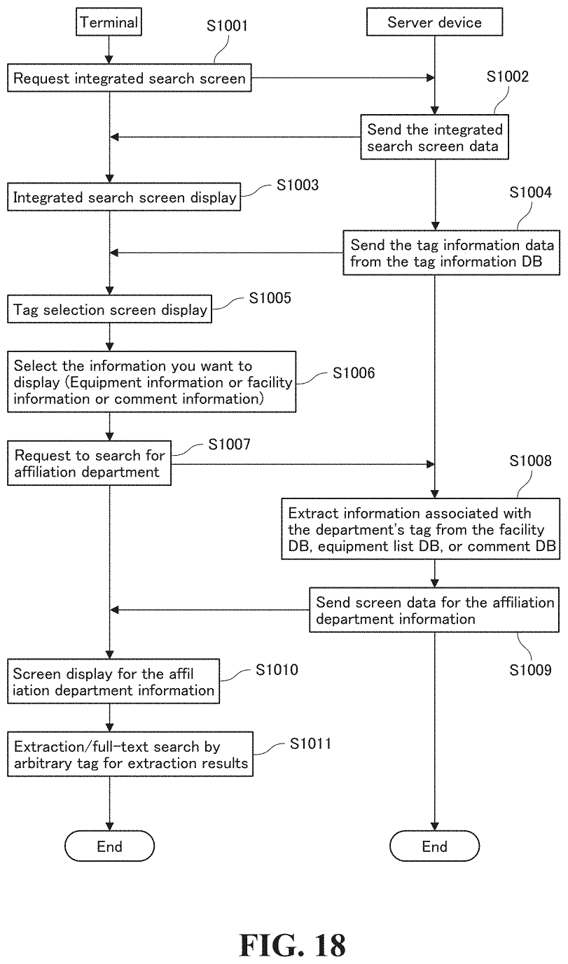

The process of displaying the belonging department information screen will be described below with reference to FIG. 18. Here, the belonging department information refers to the industrial equipment information, the facility information, and the comment information managed by the department to which the arbitrary account belongs.

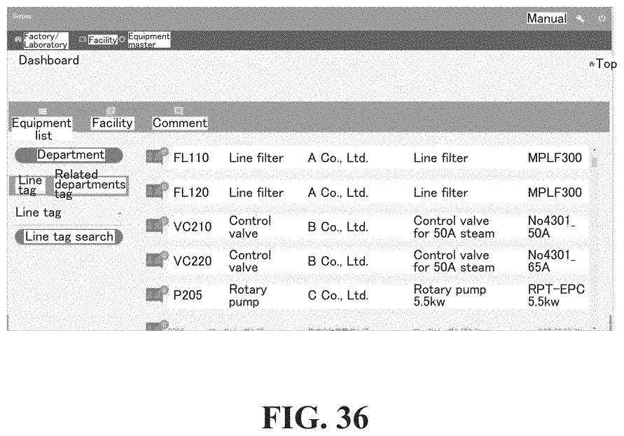

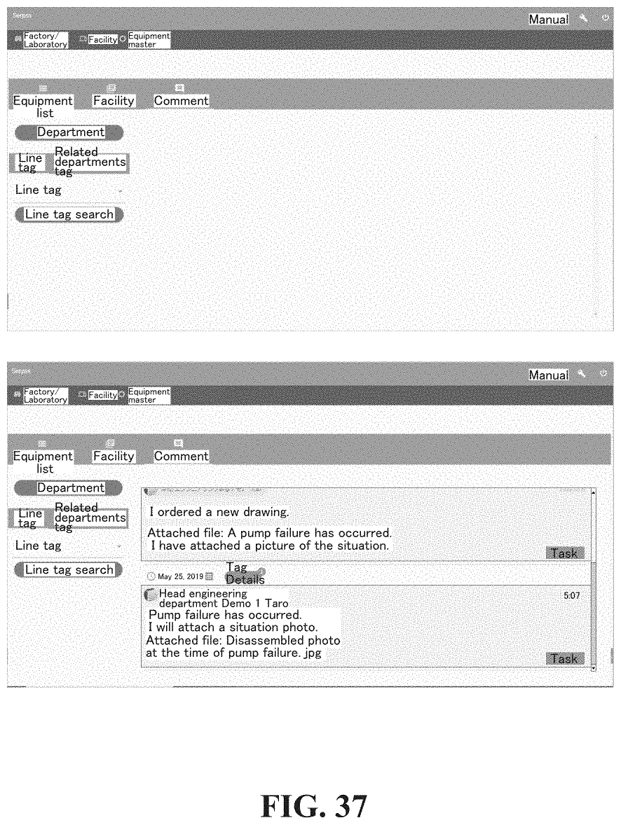

The integrated search screen request is supplied from the operation unit 32 to the maintenance management unit 18 via the information acquisition unit 12 of the server device 2 (step S 1001 and FIG. 36). When an icon corresponding to SERPSS (corresponding to the name or logo of each enterprise) is clicked on each screen, the screen transitions to the integrated search screen. Although not shown, a tab of a name such as an integrated search screen may be provided at each tab portion of the factory/laboratory, the facility, and the equipment master shown in FIG. 36 in parallel with the icon, the maintenance management unit 18 transmits the integrated search screen data (step S 1002), and transmits the tag information data from the tag information DB 9 (step S 1004). On the display unit 31 of the client terminal device 3, an integrated search screen (see FIG. 36) and a tag selection screen (a portion described with a line tag of FIG. 36 and a related department tag) are displayed (steps S 1003 and S 1005). After selecting information (equipment information, facility information, comment information) to be displayed via the operation unit 32 (step S 1006 and comment is selected at above chart in FIG. 37), an own department search request (for example, the own department search icon of the lower drawing in FIG. 37) is supplied to the maintenance management unit 18 (step S 1007), and the maintenance management unit 18 extracts the belonging department information associated with the tag of the own department from the facility information DB 5, the industrial equipment information DB 7, and the comment information DB 11 (step S 1008, S 1009). The display unit 31 displays a screen (comment information screen in the example of the lower diagram of FIG. 37) related to the extracted belonging department information (step S1010). Next, extraction and full-text search by an arbitrary tag can be performed on the extracted result (step S1011).

Processing for Displaying Screen Related to Information Associated with Tag

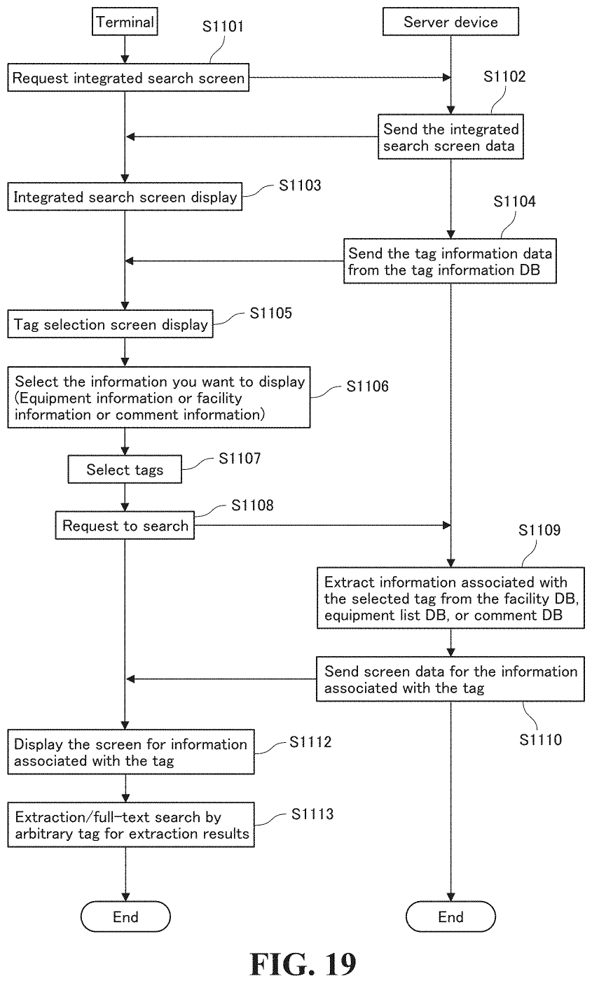

Hereinafter, a process of displaying a screen related to the information associated with the tag will be described with reference to FIG. 19. Here, the information associated with the tag refers to equipment information, facility information, and comment information in which arbitrary attribute information is associated with the tag.

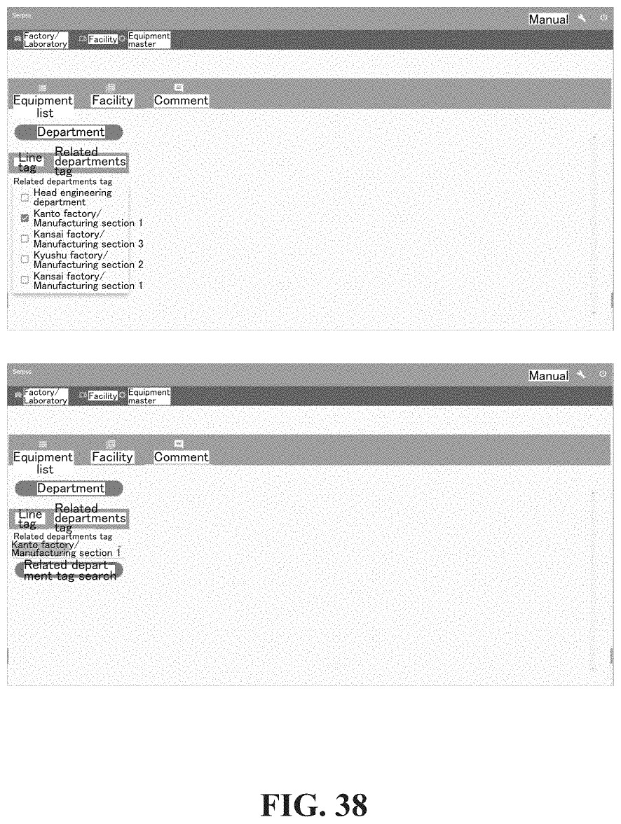

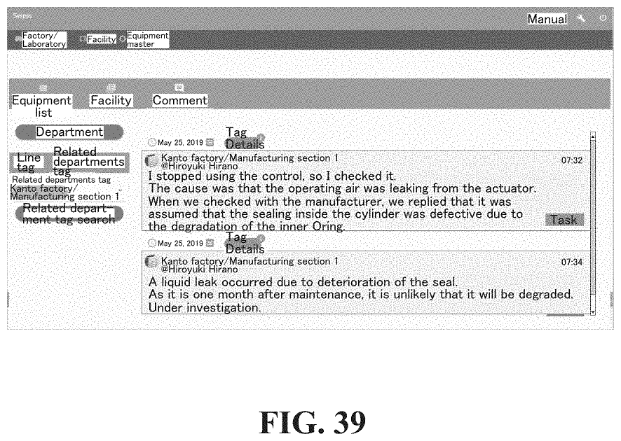

When the integrated search screen request is supplied from the operation unit 32 to the maintenance management unit 18 via the information acquisition unit 12 of the server device 2 (step S 1101, see above chart in FIG. 21), the maintenance management unit 18 transmits the integrated search screen data (step S 1102), and transmits the tag information data from the tag information DB 9 (step S 1104). On the display unit 31 of the client terminal device 3, an integrated search screen (see the top view of FIG. 21) and the tag selection screen (see FIG. 38 in FIG. 38) are displayed (steps S 1103 and S 1105). Information (equipment information, facility information, comment information) to be displayed via the operation unit 32 is selected (step S 1106, FIG. 38), and the tag is selected (step S 1107) after the tag is selected (step S 1107): For example, when the search icon is clicked (step S1108), the maintenance management unit 18 extracts the information associated with the tag selected from the facility information DB 5, the industrial equipment information DB 7, and the comment information DB 11, and supplies the screen data related to the extracted information to the display unit 31 (steps S1109 and S1110). The display unit 31 displays a screen (comment information screen in the example of FIG. 39) related to the information associated with the extracted tag (step S 1112). Next, extraction and full-text search by an arbitrary tag can be performed on the extracted result. Note that although the extraction and full-text search screen by an arbitrary tag is not shown, a screen, a search word input location, and a search condition that can be selected and selected by the tag are determined.

### Name Identification Processing

A so-called name identification process for determining and aggregating the same character string in the process data integration process of the maintenance information management system 1 will be described. For example, since registered data (character strings) are different in the same product and the same type, there is a possibility that various data (product names, model names, etc.) are not integrated, and the retrieval accuracy may deteriorate. The following name identification processing is executed by the maintenance management unit 18. According to this name identification processing, an equipment that is originally the same individual is provided. As the part is a part, information about each industrial equipment in which the registration name is different and is distributed can be aggregated. The nominal pattern is (1) name of maker name, (2) name of maker name+product name, (3) maker name+product name+type (manufacturer ID).

### Name Identification Processing Flow of Product Name and Model Name

(1) Step 1: When a manufacturer name, a product name or a model name of the registered equipment displayed on the display unit 31 is selected via the operation unit 32, the name identification candidate pop-up screen is superimposed and displayed on the display unit 31,

(2) Step 2: The name identification candidate retrieved on the basis of the manufacturer name, the product name or the model name selected on the name identification candidate pop-up screen is extracted and displayed on the display unit 31. In the search method, the name of the manufacturer, the name of the product, or the name of the model are subjected to morphological analysis and are decomposed into words to perform full-text search, and the search scores are extracted in descending order of the search scores. Since the method for calculating the search score is known, the details thereof will be omitted here.

(3) Step 3: When the name identification destination is present in the extracted name identification candidate, it is selected and the name identification processing is started. In the name identification processing, the name of the manufacturer, the name of the product, or the type information associated with the name identification source is associated with the name identification destination, and the industrial equipment list information associated with the name identification source is associated with the name identification destination. After the association processing to the name identification destination is completed, re-aggregation of the number and the like is performed.

(4) Step 4: When there is no name identification candidate in Step 2, the name identification candidate is extracted by searching with an arbitrary keyword, and the process returns to Step 3.

According to the above-described name identification processing, since the information of the industrial equipment is aggregated by the name identification and the management information (comment information or the like) stored in the industrial equipment is also automatically aggregated, the retrieval accuracy can be improved.

According to the maintenance information management system according to the present embodiment described above, the following effects can be obtained. According to the prior art, since there is a plurality of hierarchies of different attributes between a factory which is a maximum unit and a facility (equipment) which is a minimum unit, according to the present invention, information on the same industrial equipment cannot be aggregated. However, according to the present invention, tag information (a line tag, a department tag, a facility classification tag, an equipment classification tag indicating an attribute of equipment, an equipment classification tag indicating an attribute of equipment, a building. Since the tag information is associated with the account information, the factory information, the facility information, and the equipment information, the aggregation of the information of the same industrial equipment can be simplified without full-text retrieval. Therefore, since the maintenance management information can be retrieved and extracted in a short time, the efficiency of maintenance management operation can be improved.

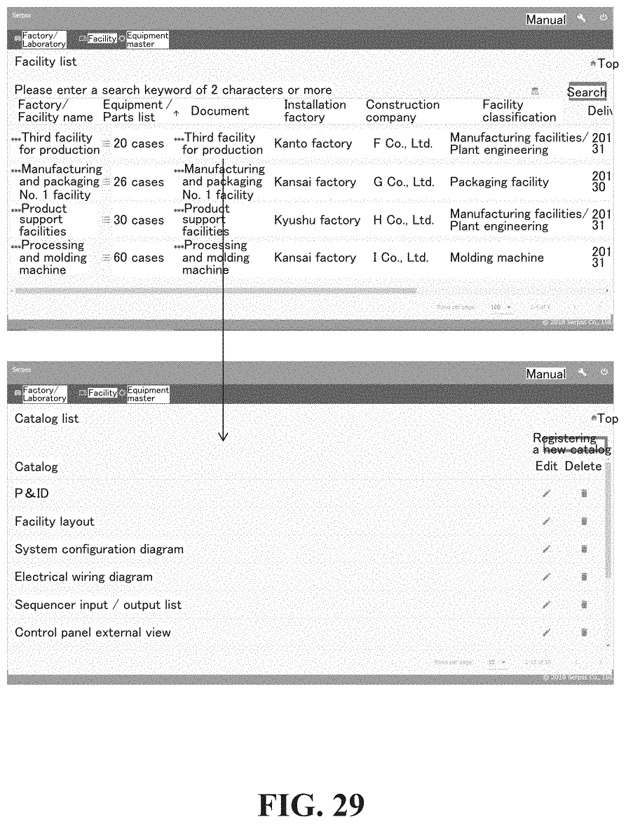

Conventionally, when a worker searches for a drawing or a comment, it is necessary to search for a folder branched on a full-text search or a tree, and it is difficult to simultaneously obtain accurate information under a plurality of parallel conditions over a factory. According to the present invention, it is possible to select a target item to be searched on the integrated search screen, select a plurality of arbitrary tags to extract information, and obtain information to be searched. After the extraction by the tag, the full-text search can be performed on the result. The registration of the drawing to be extracted as described above is performed in the following procedure. When each name of the document string is clicked in the facility list screen (see FIG. 29), the list screen is shifted from the facility list screen to the list screen (see FIG. 29), and in the figure of FIG. 29, the catalog name can be arbitrarily created by pressing the new registration icon, and various files (drawings, images, data files, and the like) can be registered with respect to the arbitrarily created catalog name. It should be noted that the method of registering the comment to be extracted is described above (refer to paragraph 72 to paragraph 74). Therefore, when the management department of the company wants to extract and investigate the facility information of a plurality of departments and the facility information of a plurality of lines from all the factories, the efficiency of maintenance management operation can be improved.

In addition, according to the prior art, in a case where, for example, a manufacturing section, an engineering section, a factory engineering section, and a head engineering section share a generated event over a different department, the conventional technique makes a search for the information by itself and is a person. Although there has been a problem that it is difficult to communicate and collect daily comments (including management information) when the establishment of the business flow and the reliable operation have not been performed, the conventional technique requires an active property for searching information by itself, and is a person who is a person who is a daily comment. There are variations due to people in the collection. According to the present invention, any equipment or equipment in equipment in the system is provided. When the registration of the comment and the registration of the file are performed on the part, the registered content (the registered date, the registered target, the registered person, the content, the presence or absence of the attached file) can be notified to the mail address registered in the account information in the system with respect to the account associated with the information sharing department tag associated with the facility. Even between different departments, by registering the generated event as a comment, it is possible to reliably notify the user of the generated event, and it is possible to reduce the risk that the information can not be shared, and to improve the efficiency of the maintenance management job.

Further, according to the present invention, any equipment in the system is provided. When a comment is registered or a file is registered for the part, the same industrial equipment. The registered content (the registered date, the registered target, the registered person, the content, the presence or absence of the attached file) can be notified to the department using the part in response to the mail address registered in the account information. Therefore, the same equipment in different departments is provided. Even when a part is used, even when the fact is not recognized in each department, the generated event is registered as a comment, and the content thereof is the same. By notifying the department using the part, it is possible to reliably notify the user of the information, and it is possible to reduce the risk that the information can not be shared, thereby improving the efficiency of the maintenance management job.

In addition, when a problem such as a trouble occurs in the industrial equipment of its own department, it is difficult to determine whether the problem is a specific problem such as a use environment of its own department or a general-purpose problem, and there is a problem that the use conditions such as the number of elapsed days, the operation time, and the number of times of operation are different from each other. As the number of objects of the industrial equipment in which the trouble has occurred is increased, it becomes more difficult to solve the above-mentioned problem in relation to the man-hours and the person's negotiation. According to the present invention, any industrial equipment can be used in a matrix screen. With respect to the part, it is possible to display the comment of all companies with the use start date as a reference with an arbitrary use condition such as the number of elapsed days, the operation time, the number of times of operation, etc. (refer to FIG. 35), and therefore, when there is a problem in the industrial equipment of the own department, it is possible to easily visually recognize whether or not there is a problem in the same use condition in all companies. Therefore, since it is possible to determine that the same problem occurs in all companies, it is possible to plan a positive correspondence in all companies regardless of the individual correspondence in the own department, and to improve the efficiency of maintenance management work.

In the related art, it has been difficult to correct and determine the maintenance cycle of the industrial equipment, the part only by its own department with less quantitative. According to the present invention, the same industrial equipment of all companies on a matrix screen is provided. The comment about the part can be displayed under an arbitrary condition (see FIG. 35), and a place where the number of arbitrary comments is large can be automatically identified, and the range can be highlighted. Thus, the same industrial equipment of all company can be provided. It is possible to quantitatively capture an event such as consumption and failure under certain conditions. Therefore, it becomes possible to perform preventive maintenance by quantitative prediction that will be broken when this condition is reached, and the cost can be suppressed by lengthening the maintenance cycle.

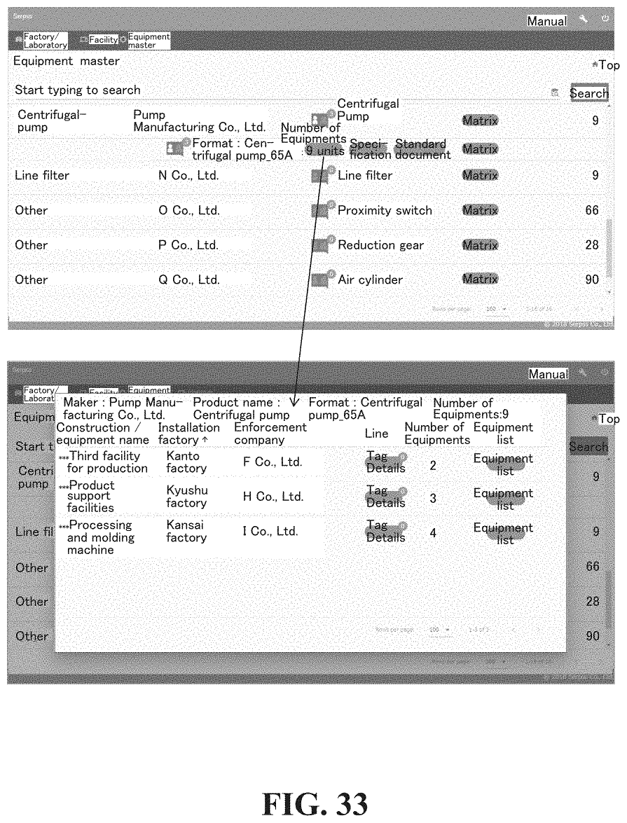

Conventionally, in a case where a failure occurs in a certain industrial equipment, it is difficult to grasp where it is used anywhere, and to totalize the number of users used in all companies. According to the present invention, the same industrial equipment is provided. As long as it is a part, it is automatically summed up in an equipment master screen (see above chart in FIG. 33), and it is possible to develop which facility of the whole company is used (see below chart in FIG. 33). Therefore, when a failure occurs, a countermeasure and a replacement are examined, the volume can be grasped quickly, the target facility can be grasped, and the efficiency of the maintenance management job can be improved.

Conventionally, when a worker searches for a comment in the drawing, it is necessary to search for a folder branched on a full-text search or a tree, and it is difficult to quickly obtain information to be searched. According to the present invention, it is possible to select a target item to be searched by an integrated search screen (see above chart in FIG. 37), select an arbitrary tag, extract information, and quickly obtain information to be searched. After the extraction by the tag, the full-text search can be performed on the result. Therefore, in a case where the facility information of a plurality of lines of a plurality of factories in which the management department of the present company is present is desired to be investigated, the efficiency of maintenance management operation can be improved.

In a conventional practice, a certain industrial equipment is provided. Attention items and work standards for the parts are distributed from the upper level in a systematic manner and distributed. Although there is a need to be well known, it is necessary to guide the material again to an employee who is not present at that time, and there is a personal person. According to the present invention, when a file is registered in a standard document button portion of an arbitrary equipment of an equipment master screen (see above chart in FIG. 33), it is possible to develop the file as a standard document of the equipment of all companies. Therefore, by referring to the standard document at the time of performing the work, it is possible to obtain an attention item and a work standard common to all companies.

The series of processes described above can be executed by hardware or may be executed by software. In a case where a series of processing is executed by software, a program constituting the software is installed from a program recording medium, for example, to a general-purpose personal computer, a tablet device, a smartphone, or the like capable of executing various functions by installing various programs, for example, by installing various programs.

The program executed by the computer may be a program in which processing is performed in time series along the order described herein, or may be a program in which processing is performed in parallel or at a necessary timing such as when calling is performed.

The embodiment of the present invention is not limited to the above-described embodiment, and various modifications can be made without departing from the gist of the present invention.

### REFERENCE SIGNS LIST

1 maintenance information management system
2 server device
3 client terminal device
4 factory information database
5 facility information database
7 industrial equipment information database
9 tag information database
10 account information database
11 comment information database
12 information acquisition unit (account information acquisition unit, second management
object information acquisition unit)
13 input control unit
14 operation input unit
15 display unit
16 display control unit
17 tag registration/update unit
18 maintenance management unit
19 account registration/update unit
21 comment registration/update unit
23 matrix tabulation unit
24 factory registration/update unit
25 equipment (facility) registration/update unit
26 industrial equipment registration/update unit
31 display unit
32 operation unit

1. A maintenance information management device, comprising:
account information acquisition unit that acquires account information of companies and employees,
a first management target information acquisition unit that acquires a first management target information related to a management target that exists for the purpose of classification,
second management target information acquisition unit that acquires a second management target information related to the management target that there is a plurality of classification items when the management target is classified by an arbitrary classification item, and
a maintenance management unit that generates maintenance management information that associates the account information and the first management target information with each of the plurality of classification items constituting the second management target information and that registers them in a database unit.

2. The maintenance information management device according to claim 1, wherein the database unit is configured to include an account information database in which the account information is registered, a first management target information database in which the first management target information is registered, and a second management target information database in which the second management target information is registered, and further comprising:
an information acquisition unit that acquires maintenance management information related to the management target associated with the selected classification item when the second management target information associated with any management target included in the first management target information is selected,
a display control unit that generates a maintenance management screen with respect to each management target based on the maintenance management information acquired by the information acquisition unit, and
a display unit that displays the maintenance management screen generated by the display control unit.

3. A maintenance information management system, comprising:
a maintenance management server device that generates and registers maintenance management information to be managed, and
a client terminal provided with a terminal-side display unit that displays maintenance information provided by the maintenance management server device, wherein the maintenance management server device comprises:
an account information acquisition unit that acquires account information of companies and employees,
a first management target information acquisition unit that acquires the first management target information related to a management target that exists for the purpose of classification,
a second management target information acquisition unit that acquires the second management target information related to the management target in which there are a plurality of classification items when the management target is classified by an arbitrary classification item, which is the management target information,
a database unit for registering the account information, the first management target information and the second management target information, a maintenance management department, and
a maintenance management unit that generates maintenance management information that associates the account information and the first management target information with each of the plurality of classification items constituting the second management target information and that registers the generated maintenance management information in the database unit.

4. The maintenance information management system according to claim 3, wherein the maintenance management server device comprises:
a maintenance management information acquisition unit that acquires maintenance management information related to the management target associated with the selected classification item when the second management target information associated with any management target included in the first management target information is selected,
a display control unit that generates a maintenance management screen in the management target unit based on the maintenance management information acquired by the maintenance management information acquisition unit, and wherein
the client terminal comprises a display unit that displays the maintenance management screen generated by the display control unit.

5. The maintenance information management system according to claim 3, wherein the first management target information is factory information, facility information, equipment information and comment information, and the second management target information is tag information configured to include line tag information, management department tag information, information sharing department tag information, facility classification tag information, equipment classification tag information, comment tag information, and free tag information that can be set arbitrarily,
wherein the maintenance management screen includes a factory information screen for displaying the factory information, a facility information screen for displaying the facility information, an equipment information screen for displaying the equipment information, the same equipment in different facilities, comment information for the same equipment, and an equipment master screen that displays information on the facility in which the same equipment is incorporated, an equipment master screen that displays the equipment classification tag to be associates with the same equipment, and a comment information screen that displays comments,
wherein the display control unit generates tag registration screen data in response to a request for a tag registration screen capable of selecting the tag information from the client terminal, and supplies the generated tag registration screen data to the terminal side display unit,
wherein the terminal side display unit displays the tag registration screen based on the supplied tag registration screen data,
wherein the registration information of the tag information is supplied to the maintenance management unit via an operation unit on the client terminal side on the displayed tag registration screen,
wherein the maintenance management unit stores the supplied tag information in the second management target information database, executes the registration process of the tag information, and associates the registered tag information with the factory information, the facility information, the equipment information and the comment information, and stores the maintenance management information including the associated factory information, the facility information, the equipment information and the comment information in the first management target information database,
wherein the display control unit generates a maintenance management screen in the management target unit based on the associated maintenance management information stored in the first management target information database, and
wherein the terminal side display unit displays the maintenance management screen generated by the display control unit.

6. A maintenance information management method for managing maintenance information to be managed by using a maintenance information management system including a maintenance management server device, comprising the steps of:
acquiring account information of companies and employees by the maintenance management server device,
acquiring a first management target information regarding the management target in which the maintenance management server device exists for the purpose of classification, and
acquiring a second management target information related to the management target having a plurality of the classification items when the maintenance management server device classifies the management target by an arbitrary classification item, which is the management target information, and
generating maintenance management information in which the account information and the first management target information are associated with each of a plurality of classification items constituting the second management target information, and registering them in the database unit by the maintenance management server device.

7. A maintenance information management method for managing maintenance information to be managed by using a maintenance information management system including a client terminal and a maintenance management server device, comprising the steps of:
acquiring account information of companies and employees via an account information acquisition department by the maintenance management server device,
acquiring a first management target information related to a management target existing for the purpose of classification by the maintenance management server device,
acquiring the second management target information related to a management target having a plurality of classification items when classifying the management target using an arbitrary classification item, which is the management target information by the maintenance management server device,
generating maintenance management information in which the account information and the first management target information are associated with each of a plurality of classification items constituting the second management target information, and registering them in a database unit by the maintenance management server device,
acquiring maintenance management information related to the management target associated with the selected classification items when the second management target information associated with any management target included in the first management target information is selected,
generating the maintenance management screen in the management target unit based on the acquired maintenance management information by the maintenance management server device, and
displaying a maintenance management screen generated in the maintenance management server device by the client terminal.

8. A program for causing a computer to execute a maintenance information management method in a maintenance information management system including a maintenance management server device, comprising the steps of:
acquiring a first management target information related to a management target existing for the purpose of classification,
acquiring a second management target information related to a management target having a plurality of classification items when classifying the management target using an arbitrary classification item, which is the management target information by a second management target information acquisition unit, and
generating and registering maintenance management information in which the account information and the first management target information are associated with each of a plurality of classification items constituting the second management target information.

9. A program for causing a computer to execute a maintenance information management method in a system comprising the steps of,
acquiring account information of companies and employees by an account information acquisition department in the maintenance management server device,
acquiring a first management target information related to a management target existing for the purpose of classification by the maintenance management server device,
acquiring a second management target information related to a management target having a plurality of classification items when classifying the management target using an arbitrary classification item, which is the management target information by the maintenance management server device,
generating maintenance management information in which the account information and the first management target information are associated with each of a plurality of classification items constituting the second management target information, and registering them in a database unit by the maintenance management server device,
acquiring maintenance management information related to a management target associated with the selected classification items when the second management target information associated with any management target included in the first management target information is selected,
generating the maintenance management screen in the management target unit based on the acquired maintenance management information by the maintenance management server device, and
displaying the maintenance management screen generated in the maintenance management server device on a display unit of the client terminal by the client terminal.
